(19) United States
(12) Patent Application Publication
(10) Pub. No.: US 2026/0160661 A1
(43) Pub. Date: Jun. 11, 2026

(54) METHOD FOR PREDICTING ADSORPTION CAPACITY OF VOLATILE ORGANIC COMPOUNDS ACROSS ADSORPTION TEMPERATURES

(71) Applicant: University of Chinese Academy of Sciences, Beijing (CN)

(72) Inventors: Zhongshen ZHANG, Beijing (CN); Zhengping HAO, Beijing (CN); Yuan WANG, Beijing (CN); Ke ZHANG, Beijing (CN); Boyi HAO, Beijing (CN); Long YUAN, Beijing (CN); Dong ZHU, Beijing (CN); Zeyu ZHAO, Beijing (CN)

(73) Assignee: University of Chinese Academy of Sciences, Beijing, BJ (CN)

(21) Appl. No.: 19/461,258

(22) Filed: Jan. 27, 2026

(30) Foreign Application Priority Data
May 8, 2025 (CN) 202510592237.1

(51) Int. Cl. G01N 15/08

(52) U.S. Cl. CPC G01N 15/0806; G01N 2015/0866

(57) ABSTRACT

A method for predicting adsorption capacity of volatile organic compounds across adsorption temperatures is provided, pertaining to the field of waste gas treatment technology. The method comprises: selecting at least two porous materials, measuring their pore structure parameters and adsorption isotherms for VOCs, and obtaining a ternary matching equation among the critical pore size that can undergo volume-filling adsorption, relative pressure, and adsorption temperature. In the present disclosure, pore size, relative pressure, and adsorption temperature are introduced as variables, along with coefficients for volume-filling and surface-covering adsorption, and the equation coefficients are determined using test data from model adsorption materials, thereby constructing an across-temperature VOCs adsorption capacity prediction equation. This equation can be applied to predict VOCs adsorption capacity and isotherms at different adsorption temperatures for adsorbents with similar surface properties.

### TECHNICAL FIELD

The present disclosure pertains to the field of waste gas treatment technology, particularly to a method for predicting adsorption capacity of volatile organic compounds across adsorption temperatures.

### BACKGROUND

Volatile organic compounds (VOCs) is a general term for a class of volatile organic chemicals. VOCs are widely utilized in various industrial processes. However, their emissions pose serious risks to both the ecological environment and human health. Among various VOCs pollution control technologies, the adsorption method has become one of the most widely utilized technologies due to its operational flexibility, high purification efficiency, broad application range, potential for resource recovery, and contribution to reduced carbon emissions. Currently, the fine and scientific control and efficient recovery of VOCs are key research points. The fine control of VOCs, the enhancement of adsorption capacity, and the optimization of adsorption materials and processes are all fundamentally dependent on the structure-activity relationship between the physical properties of the adsorbate and the structural properties of the adsorbent. Consequently, advancements in adsorption materials and technologies largely depend on the guidance of adsorption mechanisms.

The adsorption capacity prediction is based on the premise of an accurate matching relationship between the pore structure parameters of materials and their VOCs adsorption capacity, as well as on the formulation of a corresponding equation, which holds significant reference value for optimizing adsorption materials and technologies. For instance, in industrial waste gas treatment, accurate adsorption capacity prediction facilitates the rational selection of adsorption materials, leading to a reduction in treatment costs and an improvement in purification efficiency. Regarding adsorption theoretical models and equations, such as Langmuir, Dubinin-Radushkevich, and Dubinin-Astakhov models, they can be employed to fit and explain the obtained adsorption isotherms. Nevertheless, these methods do not take the pore structure parameters of the adsorbents as variables, making it impossible to predict the VOCs adsorption capacity of unknown adsorbents. Although neural network methods introduce pore structure parameters as variables, they yield statistical outcomes whose accuracy is greatly influenced by the quality of the data, and tend to lack regular theoretical explanations. Consequently, there is an urgent need to accurately quantify the matching relationship between the structural properties of adsorbents and the adsorption capacity of VOCs from a new perspective.

Volume-filling adsorption is a common phenomenon in the adsorption of gases by porous solid adsorbents. Based on the Kelvin equation, the equilibrium vapor pressure on the concave liquid surface is less than that on the flat liquid surface due to the limitations of the pore walls in a confined space. Therefore, condensed liquid tends to form in nanopores at pressures far below the saturation vapor pressure. Under certain conditions, this volume-filling adsorption can form in pores below a specific pore size, in which the density of the adsorbate is close to that in the liquid state. Therefore, there exists a critical pore size, which is the boundary size between the volume-filling and surface-covering adsorption. The study of this critical pore size provides a pointcut for quantitative analysis of the contribution of pores with different pore sizes to the VOCs adsorption capacity.

Currently, Patent Application Publication Number CN116593376A discloses a method for predicting the adsorption capacity of volatile organic compounds based on volume-filling adsorption. This method derives a predictive equation from the respective contributions of volume-filling and surface-covering adsorption to the VOCs adsorption capacity, enabling the prediction of VOCs adsorption capacities or isotherms at a specific temperature. Nevertheless, since adsorption temperature is not incorporated as a variable in this equation, the adsorption capacity prediction equation derived at a specific temperature can only be applicable for predictions at that specific target temperature. Consequently, the prediction of adsorption capacity or isotherm at any other temperature requires re-deriving the adsorption capacity prediction equation at the corresponding temperature. This requirement not only increases the workload but also limits the convenience and generalizability of the adsorption capacity/isotherm prediction method to a certain extent.

If a method for predicting the adsorption capacity of VOCs across adsorption temperatures were available, specifically one that utilizes the same adsorption capacity prediction equation to predict adsorption capacity and isotherms at various temperatures, it would significantly enhance the convenience and generalizability of the VOCs adsorption prediction equation. The adsorption capacity prediction is based on the premise of an accurate matching relationship between the pore structure parameters of materials and their VOCs adsorption capacity, as well as on the establishment of a corresponding equation, which holds significant reference value for developing and optimizing adsorption materials and technologies. Currently, there is still a lack of a method for predicting the adsorption capacity of VOCs across different adsorption temperatures with a solid theoretical basis.

### SUMMARY

In view of the foregoing, an objective of the present disclosure is to provide a method for predicting adsorption capacity of volatile organic compounds across adsorption temperatures. The prediction method provided by the present disclosure can predict the adsorption capacity and adsorption isotherm of VOCs at different adsorption temperatures through the same equation according to pore structure parameters of the adsorption material, that is, an across-temperature prediction.

In order to achieve the above objective of the present disclosure, the present disclosure provides the following technical solutions:

The present disclosure provides a method for predicting the adsorption capacity of volatile organic compounds across adsorption temperatures. The method includes the following steps:
step (1), providing at least two porous materials with concentrated pore size distributions as model adsorption materials, measuring pore structure parameters of the model adsorption materials, wherein the pore structure parameters include a pore size distribution, a change of cumulative pore volume with pore size distribution, a total pore volume V, a change of cumulative specific surface area with pore size distribution, and a total specific surface area S;
step (2), measuring adsorption isotherms of one model adsorption material for specific VOCs at multiple adsorption temperatures, and obtaining normalized static adsorption isotherms by dividing each pressure point on the static adsorption isotherms by the saturated vapor pressure P₀ at corresponding temperatures;
according to the normalized static adsorption isotherm, a corresponding relative pressure range when a volume-filling adsorption forms in the model adsorption material can be obtained, and an intermediate value of the relative pressure range is taken as a critical relative pressure P_{C}/P₀; correlate the critical relative pressure P_{C}/P₀ with an intermediate value of the pore size distribution of the model adsorption material, and the intermediate value of the pore size distribution is taken as a critical pore size D_{C} for a formation of the volume-filling adsorption at the critical relative pressure P_{C}/P₀;
linearly fitting the critical relative pressure P_{C}/P₀ and adsorption temperature T of the model adsorption material, obtaining a linear relationship equation between the critical relative pressure P_{C}/P₀ and the adsorption temperature under a specific pore size:

$${P}_{C} / {P}_{0} = {k}_{P} \times T + {d}_{P} , \qquad Equation 1$$

where P_{C}/P₀ is the critical relative pressure of a critical pressure P_{C} with respect to the saturated vapor pressure P₀ at a corresponding adsorption temperature;
T is the adsorption temperature, and the unit is ° C.;
k_{P} is the slope of the linear relationship between relative pressure and adsorption temperature;
d_{P} is the value of P_{C}/P₀ when the relative pressure approaches 0 in the linear relationship;
according to different P_{C}/P₀ values corresponding to different adsorption temperatures T of the model adsorption materials, determining the coefficients k_{P} and d_{P} in Equation 1 corresponding to the model adsorption materials;
step (3), obtaining coefficients k_{P} and d_{P} in Equation 1 corresponding to other model adsorption materials with reference to the method of step (2);
step (4), for multiple critical pore sizes D_{C}, linearly fitting k_{P} and d_{P} from the linear relationship equations between the critical relative pressure P_{C}/P₀ and the adsorption temperature T with respect to the respective critical pore sizes D_{C}, and obtaining linear relationship equations k_{P}=k_{P1}×D_{C}+k_{P0} and d_{P}=d_{P1}×D_{C}+d_{P0} of the changes in coefficients k_{P} and d_{P} with the critical pore sizes D_{C}, respectively, thereby obtaining a linear relationship equation of the volume-filling adsorption critical relative pressure P_{C}/P₀ with the changes in the adsorption temperature T and the pore size D_{C}:

$${P}_{C} / {P}_{0} = ( {k}_{P 1} \times {D}_{C} + {k}_{P 0} ) \times T + ( {d}_{P 1} \times {D}_{C} + {d}_{P 0} ) , \qquad Equation 2$$

where P_{C}/P₀ is the critical relative pressure of a critical pressure P_{C} with respect to the saturated vapor pressure P₀ at a corresponding adsorption temperature;
T is the adsorption temperature, and the unit is ° C.;
D_{C} is the critical pore size, which can form volume-filling adsorption when the relative pressure is P_{C}/P₀, and the unit is nm;
k_{P1} and k_{P0} are the slope and intercept of the linear relationship equation between k_{P} and critical pore size D_{C}, respectively;
d_{P1} and d_{P0} are the slope and intercept of the linear relationship equation between d_{P} and critical pore size D_{C}, respectively;
utilizing the Equation 2 to obtain a matching relationship equation between the critical pore size D_{C} and the adsorption temperature T for volume-filling adsorption when the relative pressure P_{C}/P₀ is different:

$${D}_{C} = ( {P}_{C} / {P}_{0} - {k}_{P 0} \times T - {d}_{P 0} ) / ( {k}_{P 1} \times T + {d}_{P 1} ) , \qquad Equation 3$$

where D_{C}, P_{C}/P₀, T, k_{P1}, k_{P0}, d_{P1} and d_{P0} denote the same meaning as in Equation 2;
step (5), taking the critical pore size D_{C} as a demarcation point, according to the change of cumulative pore volume with pore size distribution and the change of cumulative specific surface area with pore size distribution measured by the pore structure parameters, obtaining a pore volume V_{C} of the pores below the critical pore size D_{C} and a specific surface area S_{C} of the pores above the critical pore size D_{C} for the model adsorption material, respectively;
step (6), based on the contribution of the pore volume V_{C} of the pores where volume-filling adsorption forms and the specific surface area S_{C} of the pores where surface-covering adsorption forms to the VOCs adsorption capacity, and introducing the pore size, relative pressure and adsorption temperature of different model adsorption materials as parameters into the adsorption capacity prediction equation, obtaining an across-temperature VOCs adsorption capacity prediction equation, which enables the adsorption isotherms prediction to be extended to different adsorption temperatures T:

$$Q = a \times {V}_{C} + b \times {S}_{C} = f ( {D}_{A V} , P / {P}_{0} , T ) \times {V}_{C} + ℊ ( {D}_{A S} , P / {P}_{0} , T ) \times {S}_{C} ; \qquad Equation 4$$

where Q is the quantity of adsorbed VOCs per unit mass of adsorption material, and the unit is g/g;
V_{C} is the pore volume of the pores below the critical pore size, that is, the critical pore volume, and the unit is cm³/g;
S_{C} is the specific surface area of the pores above the critical pore size, that is, the critical specific surface area, and the unit is m²/g;
D_{AV} is the average pore size of the pores where volume-filling adsorption forms, and the unit is nm; where D_{AV}=AV_{C}/(S−S_{C}), S is a total specific surface area, and the unit is m²/g;
D_{AS} is the average pore size of the pores where surface-covering adsorption forms, and the unit is nm; where D_{AS}=4 (V−V_{C})/−S_{C}, V is the total pore volume, and the unit is cm³/g;
T is the adsorption temperature, and the unit is ° C.;
P/P₀ is any relative pressure point on the adsorption isotherm normalized to the saturated vapor pressure at the corresponding temperature; P₀ is saturated vapor pressure of VOCs at the corresponding adsorption temperature T, and the unit is mbar;
α is the coefficient of the volume-filling adsorption, that is, the adsorption capacity of VOCs per unit pore volume, and the unit is g/cm³, where α=f(D_{AV}, P/P₀, T) denotes that the coefficient a is a function of the average pore size D_{AV}, the relative pressure P/P₀ and the adsorption temperature T;
b is the coefficient of the surface-covering adsorption, that is, the adsorption capacity of VOCs per unit specific surface area, and the unit is g/m², where b=f(D_{AS}, P/P₀, T) denotes that the coefficient b is a function of the average pore size D_{AS}, the relative pressure P/P₀ and the adsorption temperature T;
step (7), by measuring the pore structures of multiple model adsorption materials and the adsorption isotherms under different adsorption conditions, obtaining the critical pore size D_{C}, quantity of adsorbed VOCs Q, critical pore volume V_{C}, critical specific surface area S_{C}, and average pore sizes D_{AV} and D_{AS} under the corresponding conditions, taking the pore structure parameters of the model adsorption materials and the adsorption isotherms of specific VOCs under different adsorption conditions as known data, substituting them into Equation 4 to obtain specific values of a and b, and obtaining the across-temperature VOCs adsorption capacity prediction equation.

In some embodiments, the model adsorption material is at least one of an ordered mesoporous silica, an ordered mesoporous carbon and molecular sieves with concentrated pore size distributions.

In some embodiments, the VOCs are one of hydrocarbon organics, oxygen-containing organics, halogen-containing organics, nitrogen-containing organics and sulfur-containing organics.

The present disclosure provides a method for predicting adsorption capacity of volatile organic compounds across adsorption temperatures. In the present disclosure, at least two model adsorption materials with concentrated pore size distributions and a control variate method are employed, and on the basis of normalizing the pressure of adsorption isotherms with respect to saturated vapor pressure at corresponding adsorption temperatures, a regularity equation of critical pore sizes at which specific VOCs can undergo volume-filling adsorption under different adsorption conditions (temperature, relative pressure) is obtained. Since pores smaller than the critical pore size D_{C} undergo volume-filling adsorption with high pore volume utilization, the volume-filling adsorption follows the volume-filling adsorption mechanism of the adsorption space, and the adsorption capacity of VOCs by this part of the pore channels is directly related to the pore volume. The pores larger than the critical pore size D_{C} undergo the surface-covering adsorption with a single-layer or multi-layer adsorption mechanism, and the adsorption capacity of VOCs by this part of the pore is directly related to the specific surface area. On this basis, according to the pore volume where volume-filling adsorption forms and the specific surface area of the pore where surface-covering adsorption forms, the adsorption capacity prediction equation is proposed. Because the adsorption mechanisms of the two parts are different, their contribution to VOCs adsorption capacity and calculation methods are also different. In the present disclosure, the pore size D, the relative pressure P/P₀ and the adsorption temperature T are taken as variables, the coefficients of volume-filling adsorption and surface-covering adsorption are introduced, and at least two model material pore structure parameters and their adsorption isotherms to VOCs are used as known data to determine the equation coefficients, thus obtaining an across-temperature VOCs adsorption capacity prediction equation. This equation can be used to predict the adsorption capacity and isotherms of VOCs at different adsorption temperatures for adsorbents with the same or similar surface properties.

The method for predicting the adsorption capacity of volatile organic compounds across adsorption temperatures provided in the present disclosure possesses a solid theoretical basis, wherein all variables in the equations have clear physical meanings. As the embodiment results demonstrate, the adsorption isotherms obtained by the prediction method of the present disclosure show a high degree of coincidence with the measured data. Moreover, the method is also applicable to adsorption materials lacking a concentrated pore size distribution, exhibiting good accuracy and generalizability for predicting the adsorption capacity and isotherms of specific VOCs at various temperatures. In summary, the prediction method of the present disclosure features simple computation, clear physical meaning, high accuracy, and wide application range, thereby providing a reference basis for selecting adsorption materials suitable for different VOCs and providing a theoretical support for the design of high-efficiency VOCs adsorption materials, the study of adsorption and desorption mechanisms, and the optimization of VOCs adsorption processes.

### BRIEF DESCRIPTION OF THE DRAWINGS

FIG. 1 is a schematic diagram of a method for predicting adsorption capacity of volatile organic compounds across adsorption temperatures;

FIG. 2 is a pore size distribution of a model adsorption material in Embodiment 1;

FIG. 3 shows a change in a cumulative pore volume with pore size of a model adsorption material in Embodiment 1;

FIG. 4 shows a change in a cumulative specific surface area with pore size of a model adsorption material in Embodiment 1;

FIG. 5 is a static adsorption isotherm of a model adsorption material for benzene at multiple adsorption temperatures in Embodiment 1;

FIG. 6 is a normalized static adsorption isotherm of benzene obtained with respect to saturated vapor pressure P₀ at each adsorption temperature in Embodiment 1;

FIG. 7 is a linear relationship equation between critical relative pressure (P_{C}/P₀) and adsorption temperature (T) at which benzene undergoes volume-filling adsorption in pores of different sizes in Embodiment 1;

FIG. 8 is a linear relationship equation for changes in coefficients k_{P} and d_{P} with the critical pore size D_{C} in Equation 1 during adsorption process of benzene at various temperatures in Embodiment 1;

FIG. 9 shows a pore volume of pores in a specific pore size range obtained through a cumulative pore volume in Embodiment 1;

FIG. 10 shows a specific surface area of pores in a specific pore size range obtained through a cumulative specific surface area in Embodiment 1;

FIG. 11 is a trend curve of a coefficient of the volume-filling adsorption (a) with pressure changes for model adsorption materials with different pore sizes in Embodiment 1;

FIG. 12 shows an influence curve of adsorption temperature T on a coefficient of the volume-filling adsorption a in Embodiment 1;

FIG. 13 is a trend curve of a coefficient of the surface-covering adsorption (b) with pressure changes for model adsorption materials with different pore sizes in Embodiment 1;

FIG. 14 shows an influence curve of adsorption temperature T on a coefficient of the surface-covering adsorption (b) in MCM-41-3.0 in Embodiment 1;

FIG. 15 shows an influence curve of adsorption temperature T on a coefficient of the surface-covering adsorption (b) in MCM-41-4.0 in Embodiment 1;

FIG. 16 shows an influence curve of adsorption temperature T on a coefficient of the surface-covering adsorption (b) in MCM-41-4.5 in Embodiment 1;

FIG. 17 shows a trend of a slope k_{b} with pore size changes at 5° C. and 45° C. in Embodiment 1;

FIG. 18 shows a change of coefficients of an equation of a slope k_{b} with a temperature and a pore size in Embodiment 1;

FIG. 19 is a comparison between a benzene prediction obtained by an across-temperature adsorption capacity prediction Equation 4.1 and a measured normalized adsorption isotherm of a MCM-41 adsorption material at different adsorption temperatures in Embodiment 1;

FIG. 20 is a comparison between predicted and measured adsorption isotherms of a MCM-41 adsorption material obtained by multiplying relative pressure P/P₀ in an isotherm by saturated vapor pressure P₀ at a corresponding temperature at five different adsorption temperatures in Embodiment 1;

FIG. 21 shows a pore size distribution of a porous silica material without a concentrated pore size distribution in Embodiment 2;

FIG. 22 is a comparison between a quantity of predicted and measured adsorption Q with relative pressure P/P₀ at adsorption temperature of 25° C. for a porous silica material without a concentrated pore size distribution in Embodiment 2;

FIG. 23 shows a comparison between predicted and measured adsorption isotherms at adsorption temperature of 25° C. for a porous silica material without a concentrated pore size distribution in Embodiment 2;

FIG. 24 is a static adsorption isotherm of a model adsorption material for acetone at 5° C., 15° C., 25° C., 35° C., and 45° C. in Embodiment 3;

FIG. 25 is a static adsorption isotherm of acetone normalized with respect to saturated vapor pressure at each temperature in Embodiment 3;

FIG. 26 is a linear relationship equation between critical relative pressure (P_{C}/P₀) and adsorption temperature (T) in pores of different sizes in Embodiment 3;

FIG. 27 shows a linear relationship equation for changes in coefficients k_{P} and d_{P} with a critical pore size D_{C} in Equation 1 during an adsorption process of acetone at different adsorption temperatures in Embodiment 3;

FIG. 28 is a trend curve of a coefficient of the volume-filling adsorption (a) with pressure changes for model adsorption materials with different pore sizes in Embodiment 3;

FIG. 29 shows an influence curve of adsorption temperature T on a coefficient of the volume-filling adsorption a in Embodiment 3;

FIG. 30 shows an influence curve of material pore size and adsorption temperature T on a coefficient of the surface-covering adsorption (b) in model adsorption materials with different pore sizes in Embodiment 3;

FIG. 31 shows a change of coefficients of an equation of a slope k_{P} with temperature and pore size in Embodiment 3;

FIG. 32 is a comparison of predicted and measured adsorption isotherms of acetone adsorption by MCM-41-4.0 at different adsorption temperatures in Embodiment 3;

FIG. 33 shows a pore size distribution of two kinds of porous silica materials without a concentrated pore size distribution in Embodiment 4;

FIG. 34 is a comparison between a quantity of predicted and measured adsorption Q with relative pressure P/P₀ of the acetone adsorption by two porous silica materials without concentrated pore size distributions at a temperature of 35° C. in Embodiment 4;

FIG. 35 is a comparison between predicted and measured adsorption isotherms before normalization for an acetone adsorption by a porous silica material without a concentrated pore size distribution at a temperature of 35° C. in Embodiment 4.

### DETAILED DESCRIPTION OF THE EMBODIMENTS

The present disclosure provides a method for predicting adsorption capacity of volatile organic compounds across adsorption temperatures; the method includes the following steps:
step (1), at least two porous materials with concentrated pore size distributions are provided as model adsorption materials, pore structure parameters of the model adsorption materials are measured, wherein the pore structure parameters include the pore size distribution, the change of cumulative pore volume with pore size distribution, the total pore volume V, the change of cumulative specific surface area with pore size distribution, and the total specific surface area S;
step (2), the adsorption isotherms of one model adsorption material for specific VOCs at multiple adsorption temperatures are measured, and the normalized static adsorption isotherms are obtained by dividing each pressure point on the static adsorption isotherms by the saturated vapor pressure P₀ at the corresponding temperatures;
according to the normalized static adsorption isotherm, the corresponding relative pressure range is obtained when volume-filling adsorption forms in the model adsorption material, and the intermediate value of the relative pressure range is taken as the critical relative pressure P_{C}/P₀; correlate the critical relative pressure P_{C}/P₀ with the intermediate value of the pore size distribution of the model adsorption material, and the intermediate value of the pore size distribution is taken as the critical pore size D_{C} for the formation of the volume-filling adsorption at the critical relative pressure P_{C}/P₀;
the critical relative pressure P_{C}/P₀ and the adsorption temperature T of the model adsorption material are linearly fitted, and the linear relationship equation between the critical relative pressure P_{C}/P₀ and the adsorption temperature is obtained under the specific pore size:

$${P}_{C} / {P}_{0} = {k}_{P} \times T + {d}_{P} , \qquad Equation 1 ;$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
k_{P} is the slope of the linear relationship between relative pressure and adsorption temperature;
d_{P} is the value of P_{C}/P₀ when the relative pressure approaches 0 in the linear relationship;
according to different P_{C}/P₀ values corresponding to different adsorption temperatures T of the model adsorption materials, the coefficients k_{P} and d_{P} in Equation 1 corresponding to the model adsorption materials are determined;
step (3), the coefficients k_{P} and d_{P} in Equation 1 corresponding to other model adsorption materials are obtained with reference to the method of step (2);
step (4), for multiple critical pore sizes D_{C}, k_{P} and d_{P} from the linear relationship equations between the critical relative pressure P_{C}/P₀ and the adsorption temperature T are linearly fitted with respect to the respective critical pore sizes D_{C}, and the linear relationship equations k_{P}=k_{P1}× D_{C}+k_{P0} and d_{P}=d_{P1}×D_{C}+d_{P0} of the changes in coefficients k_{P} and d_{P} with the critical pore sizes D_{C} are obtained, respectively, thereby obtaining the linear relationship equation of the volume-filling adsorption critical relative pressure P_{C}/P₀ with changes in the adsorption temperature T and the pore size D_{C}:

$${P}_{C} / {P}_{0} = ( {k}_{P 1} \times {D}_{C} + {k}_{P 0} ) \times T + ( {d}_{P 1} \times {D}_{C} + {d}_{P 0} ) , \qquad Equation 2 ;$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
D_{C} is the critical pore size, which can form volume-filling adsorption when the relative pressure is P_{C}/P₀, and the unit is nm;
k_{P1} and k_{P0} are the slope and intercept of the linear relationship equation between k_{P} and critical pore size D_{C}, respectively;
d_{P1} and d_{P0} are the slope and intercept of the linear relationship equation between d_{P} and critical pore size D_{C}, respectively;
the Equation 2 is utilized to obtain the matching relationship equation between the critical pore size D_{C} and the adsorption temperature T for volume-filling adsorption when the relative pressure P_{C}/P₀ is different:

$${D}_{C} = ( {P}_{C} / {P}_{0} - {k}_{P 0} \times T - {d}_{P 0} ) / ( {k}_{P 1} \times T + {d}_{P 1} ) , \qquad Equation 3 ;$$

where D_{C}, P_{C}/P₀, T, k_{P1}, k_{P0}, d_{P1} and d_{P0} denote the same meaning as in Equation 2;
step (5), the critical pore size D_{C} is taken as the demarcation point, according to the change of cumulative pore volume with pore size distribution and the change of cumulative specific surface area with pore size distribution measured by the pore structure parameters, the pore volume V_{C} of the pores below the critical pore size D_{C} and the specific surface area S_{C} of the pores above the critical pore size D_{C} for the model adsorption material are obtained, respectively;
step (6), based on the contribution of the pore volume V_{C} of the pores where volume-filling adsorption forms and the specific surface area S_{C} of the pores where surface-covering adsorption forms to the VOCs adsorption capacity, and the pore size, relative pressure and adsorption temperature of different model adsorption materials as parameters are introduced into the adsorption capacity prediction equation, the across-temperature VOCs adsorption capacity prediction equation is obtained, which enables the adsorption isotherms prediction to be extended to different adsorption temperatures T:

$$Q = a \times {V}_{C} + b \times {S}_{C} = f ( {D}_{A V} , P / {P}_{0} , T ) \times {V}_{C} + ℊ ( {D}_{A S} , P / {P}_{0} , T ) \times {S}_{C} ; \qquad Equation 4$$

in Equation 4,
where Q is the quantity of adsorbed VOCs per unit mass of adsorption material, and the unit is g/g;
V_{C} is the pore volume of the pores below the critical pore size, that is, the critical pore volume, and the unit is cm³/g;
S_{C} is the specific surface area of the pores above the critical pore size, that is, the critical specific surface area, and the unit is m²/g;
D_{AV} is the average pore size of the pores where volume-filling adsorption forms, and the unit is nm; where D_{AV}=4V_{C}/(S−S_{C}), S is the total specific surface area, and the unit is m²/g;
D_{AS} is the average pore size of the pores where surface-covering adsorption forms, and the unit is nm; where D_{AS}=4 (V−V_{C})/−S_{C}, V is the total pore volume, and the unit is cm³/g;
T is the adsorption temperature, and the unit is ° C.;
P/P₀ is any relative pressure point on the adsorption isotherm normalized to the saturated vapor pressure at the corresponding temperature; P₀ is the saturated vapor pressure of VOCs at the corresponding adsorption temperature T, and the unit is mbar;
a is the coefficient of the volume-filling adsorption, that is, the adsorption capacity of VOCs per unit pore volume, and the unit is g/cm³, where a=f(D_{AV}, P/P₀, T) denotes that the coefficient a is the function of the pore size D_{AV}, the relative pressure P/P₀, and the adsorption temperature T;
b is the coefficient of the surface-covering adsorption, that is, the adsorption capacity of VOCs per unit specific surface area, and the unit is g/m², where b=f(D_{AS}, P/P₀, T) denotes that the coefficient b is the function of the pore size D_{AS}, the relative pressure P/P₀, and the adsorption temperature T;
step (7), by measuring the pore structures of multiple model adsorption materials and the adsorption isotherms under different adsorption conditions, the critical pore size D_{C}, quantity of adsorbed VOCs Q, critical pore volume V_{C}, critical specific surface area S_{C}, and average pore sizes D_{AV} and D_{AS} under the corresponding conditions are obtained, the pore structure parameters of the model adsorption materials and the adsorption isotherms of specific VOCs under different adsorption conditions are taken as known data, and they are substituted into Equation 4 to obtain specific values of a and b, and the across-temperature VOCs adsorption capacity prediction equation is obtained.

In the present disclosure, at least two porous materials with concentrated pore size distribution are provided as model adsorption materials, pore structure parameters of the model adsorption materials are measured, wherein the pore structure parameters include the pore size distribution, the change of cumulative pore volume with pore size distribution, the total pore volume V, the change of cumulative specific surface area with pore size distribution, and the total specific surface area S. In the present disclosure, the model adsorption material is preferably at least one of the ordered mesoporous silica, the ordered mesoporous carbon and molecular sieves with concentrated pore size distribution. In the present disclosure, when the pore size distribution is concentrated within the range of 2.0 nm, and the specific surface area of the pores accounts for greater than 90% of the total specific surface area of the material, the adsorption material with a concentrated pore size distribution is set. In the present disclosure, the pore size of the concentrated distribution of the adsorption material is preferably in the range of micropores and small mesopores, and the pore size thereof is equal to or several times the molecular size of the VOCs.

The present disclosure uses a commercial specific surface area and pore structure analyzer to measure the pore structure parameters of the adsorption material, and obtains the pore structure parameters of the adsorption material through the calculation model of density functional theory (DFT) cylindrical pores.

In the present disclosure, the adsorption isotherms of one model adsorption material for specific VOCs at multiple adsorption temperatures are measured, and the normalized static adsorption isotherm is obtained by dividing each pressure point on the static adsorption isotherms by the saturated vapor pressure P₀ at the corresponding temperature. According to the normalized static adsorption isotherm, the relative pressure range corresponding to the volume-filling adsorption of the model adsorption material is obtained, and the intermediate value of the relative pressure range is taken as the critical relative pressure P_{C}/P₀; the critical relative pressure P_{C}/P₀ and the adsorption temperature T of the model adsorption material are linearly fitted, the linear relationship equation between the critical relative pressure P_{C}/P₀ and the adsorption temperature is obtained under the specific pore size. For the model adsorption material with a concentrated pore size distribution, its adsorption isotherm shows typical VI adsorption isotherm characteristics. When volume-filling adsorption forms, its adsorption capacity will increase rapidly within a specific pressure range. This change can intuitively reflect the critical pressure value P_{C} corresponding to the model adsorption material with a specific pore size when volume-filling adsorption forms from the adsorption isotherm.

According to the Kelvin equation, the adsorption of gas molecules on a porous material results in volume-filling adsorption in pores below a specific size. It can be found that at the same pore size, the corresponding relative pressure required for volume-filling adsorption becomes greater as the adsorption temperature increases, and there is a correlation between the critical relative pressure P_{C}/P₀ and the corresponding adsorption temperature T. Under the same adsorption temperature, the larger the pore size of the model adsorption material, the greater the corresponding relative pressure required for volume-filling adsorption, and there is a correlation between the relative pressure and the corresponding critical pore size. By matching the critical relative pressure at various temperatures in the same pore size with the adsorption temperature, the linear relationship equation between the critical relative pressure (P_{C}/P₀) and the adsorption temperature (T) at a specific pore size can be obtained by linear fitting:

$${P}_{C} / {P}_{0} = {k}_{P} \times T + {d}_{P} , \qquad Equation 1.$$

According to different P_{C}/P₀ values corresponding to different adsorption temperatures T of the model adsorption materials, the coefficients k_{P} and d_{P} in Equation 1 corresponding to the model adsorption materials are determined; further, the coefficients k_{P} and d_{P} in Equation 1 corresponding to other model adsorption materials are obtained.

In the present disclosure, under multiple critical pore sizes D_{C}, the k_{P} and d_{P} from the linear relationship equations between the critical relative pressure P_{C}/P₀ and the adsorption temperature T are linearly fitted with respect to the respective critical pore sizes D_{C}, and the linear relationship equations k_{P}=k_{P1}×D_{C}+k_{P0} and d_{P}=d_{P1}×D_{C}+d_{P0} of the changes in coefficients k_{P} and d_{P} with the critical pore sizes D_{C} are obtained, respectively, thereby obtaining the linear relationship equation of the volume-filling adsorption critical relative pressure P_{C}/P₀ with changes in the adsorption temperature T and the pore size D_{C}:

$${P}_{C} / {P}_{0} = ( {k}_{P 1} \times {D}_{C} + {k}_{P 0} ) \times T + ( {d}_{P 1} \times {D}_{C} + {d}_{P 0} ) , \qquad Equation 2.$$

By utilizing this equation, the matching relationship between the critical relative pressure P_{C}/P₀ and the critical pore size D_{C} for volume-filling adsorption at different adsorption temperatures T can be determined.

Further, in the present disclosure, the Equation 2 is utilized to obtain the matching relationship equation between the critical pore size D_{C} and the adsorption temperature T for volume-filling adsorption when the relative pressure P_{C}/P₀ is different:

$${D}_{C} = ( {P}_{C} / {P}_{0} - {k}_{P 0} \times T - {d}_{P 0} ) / ( {k}_{P 1} \times T + {d}_{P 1} ) , \qquad Equation 3.$$

In the present disclosure, Equation 3 is utilized to determine the critical pore size D_{C} corresponding to the critical point where volume-filling adsorption forms at different adsorption temperatures T and relative pressures P/P₀. The critical pore size D_{C} is taken as the demarcation point, according to the results of pore structure test, the pore volume V_{C} of the pores below any critical pore size D_{C} and the specific surface area S_{C} of the pores above any critical pore size D_{C} for the model adsorption material are obtained, respectively. Equation 3 is utilized to determine the matching relationship between the critical relative pressure P_{C}/P₀ and the critical pore size D_{C} at the corresponding adsorption temperature T, and the critical pore size D_{C} corresponding to different relative pressures is obtained. Combined with the pore structure parameters, the critical pore volume V_{C} and critical specific surface area S_{C} corresponding to different critical pore sizes D_{C} can be obtained. The pores smaller than the critical pore size D_{C} undergo volume-filling adsorption with high pore volume utilization, the volume-filling adsorption follows the volume-filling adsorption mechanism of the adsorption space, and the adsorption capacity of VOCs by this part of the pore channels is directly related to the pore volume. The pores larger than the critical pore size D_{C} undergo the surface-covering adsorption with a single-layer or multi-layer adsorption mechanism, and the adsorption capacity of VOCs by this part of the pore is directly related to the specific surface area. The adsorption mechanisms of the two parts are different, thus their contributions to the total VOCs adsorption capacity and the calculation methods also differ.

In the present disclosure, based on the contribution of the pore volume V_{C} of the pores where volume-filling adsorption forms and the specific surface area S_{C} of the pores where surface-covering adsorption forms to the VOCs adsorption capacity, and the pore size, relative pressure and adsorption temperature of different model adsorption materials as parameters are introduced into the adsorption capacity prediction equation, the across-temperature VOCs adsorption capacity prediction equation is obtained, which enables the adsorption isotherms prediction to be extended to different adsorption temperatures T:

$$Q = a \times {V}_{C} + b \times {S}_{C} = f ( {D}_{A V} , P / {P}_{0} , T ) \times {V}_{C} + ℊ ( {D}_{AS} , P / {P}_{0} , T ) \times {S}_{C} . \qquad Equation 4$$

By measuring the pore structures of multiple model adsorption materials and the adsorption isotherms under different adsorption conditions, the critical pore size D_{C}, quantity of adsorbed VOCs Q, critical pore volume V_{C}, critical specific surface area S_{C}, average pore sizes D_{AV} and D_{AS} under the corresponding conditions are obtained, the pore structure parameters of the model adsorption materials and the adsorption isotherms of specific VOCs under different adsorption conditions are taken as known data, and they are substituted into Equation 4 to obtain specific values of a and b, and the across-temperature VOCs adsorption capacity prediction equation is obtained.

In the present disclosure, based on the obtained across-temperature VOCs adsorption capacity prediction equation, through the pore structure parameters of the model adsorption material, the critical pore volume V_{C} and the critical specific surface area S_{C} corresponding to the critical pore size D_{C} under the corresponding adsorption conditions (adsorption temperature T, and relative pressure P/P₀) are substituted into the equation as known data, and the trend of changes in adsorption capacity with relative pressure P/P₀ at different adsorption temperatures is determined. By multiplying the predicted relative pressure P/P₀ of the adsorption isotherms by the saturated vapor pressure P₀ at the corresponding temperature, the predicted adsorption isotherms before normalization at the corresponding adsorption temperature can be obtained. This achieves the prediction of VOCs adsorption capacities and isotherms at various temperatures using the same equation.

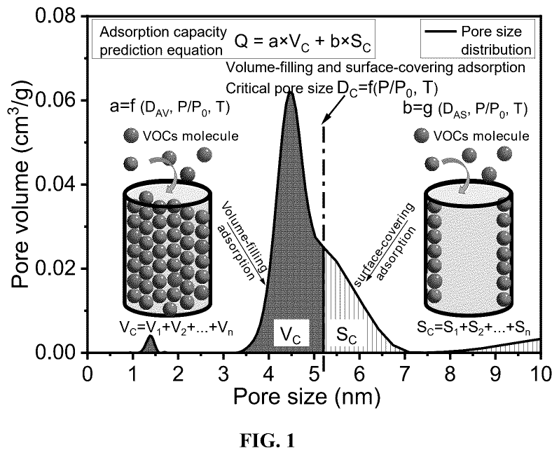

In the present disclosure, the schematic diagram of a method for predicting adsorption capacity of volatile organic compounds across adsorption temperatures is shown in FIG. 1. In FIG. 1, under specific adsorption conditions (specific VOCs types, temperature, and pressure), for different pore sizes, pores smaller than the critical pore size (D_{C}) undergo volume-filling adsorption, while pores larger than the critical pore size (D_{C}) undergo surface-covering adsorption. Commercial instruments can measure pore structure data, to obtain the total pore volume (V_{C}=V₁+V₂+ . . . +Vₙ) for all pores smaller than the critical pore size (D_{C}) and the specific surface area (S_{C}=S₁+S₂+ . . . +Sₙ) for all pores larger than the critical pore size (D_{C}). By taking pore size D, relative pressure P/P₀, and adsorption temperature T as variables, and introducing coefficients for volume-filling adsorption and surface-covering adsorption, the across-temperature VOCs adsorption capacity prediction equation is obtained. This equation can be used to predict the adsorption capacity and isotherms of VOCs at different adsorption temperatures for adsorbents with the same or similar surface properties.

Based on the obtained across-temperature VOCs adsorption capacity prediction equation, through the pore structure parameters of the model adsorption material, the critical pore volume V_{C} and the critical specific surface area S_{C} corresponding to the critical pore size D_{C} under the corresponding adsorption conditions (adsorption temperature T, and relative pressure) are substituted into the equation as known data, and the trend of changes in adsorption capacity with relative pressure P/P₀ at different adsorption temperatures is determined. By multiplying the predicted relative pressure P/P₀ of the adsorption isotherms by the saturated vapor pressure P₀ at the corresponding temperature, the predicted adsorption isotherms before normalization at the corresponding adsorption temperature can be obtained. This achieves the prediction of VOCs adsorption capacities and isotherms at various temperatures using the same equation.

The following is a detailed description of the method for predicting adsorption capacity of volatile organic compounds across adsorption temperatures provided by the present disclosure in conjunction with embodiments. However, these should not be construed as a limitation on the scope of protection of the present disclosure.

### Embodiment 1

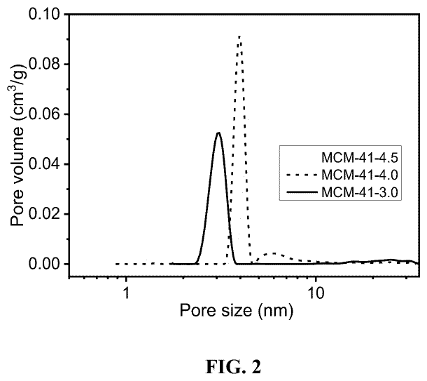

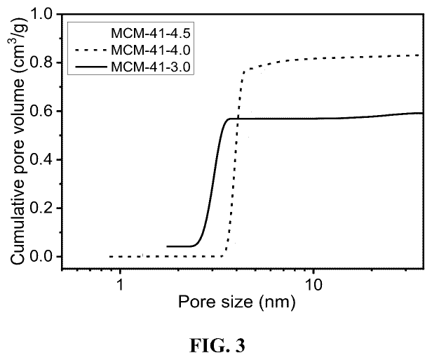

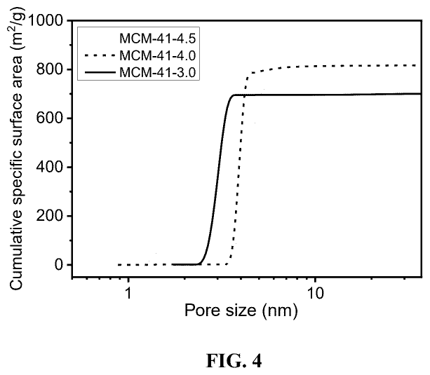

A series of ordered mesoporous silica MCM-41 materials with concentrated pore size distributions is used as model adsorption materials, which are named MCM-41-3.0, MCM-41-4.0 and MCM-41-4.5, respectively. With the help of a commercial pore structure and specific surface area tester, the pore size distribution of the materials is obtained through the DFT cylindrical pore calculation model. The results show that the series of model adsorption materials have concentrated pore size distribution, and the most probable pore sizes are 3.0 nm, 4.0 nm and 4.5 nm, respectively. The pore size distribution of the model adsorption material is shown in FIG. 2. The change of cumulative pore volume with pore size, as shown in FIG. 3, and the change of cumulative specific surface area with pore size, as shown in FIG. 4, are obtained, respectively.

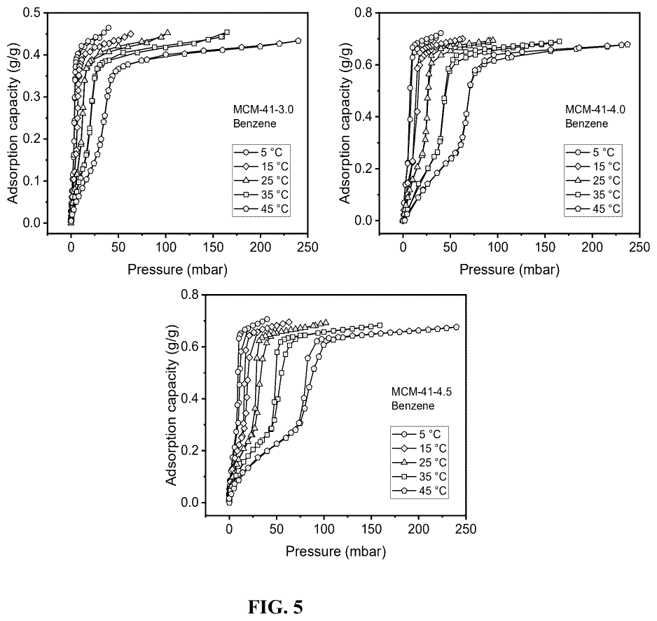

The static adsorption isotherms of benzene at 5° C., 15° C., 25° C., 35° C. and 45° C. are measured for three model adsorbents with the most probable pore sizes of 3.0 nm, 4.0 nm and 4.5 nm by an intelligent gravimetric analyzer (IGA), as shown in FIG. 5.

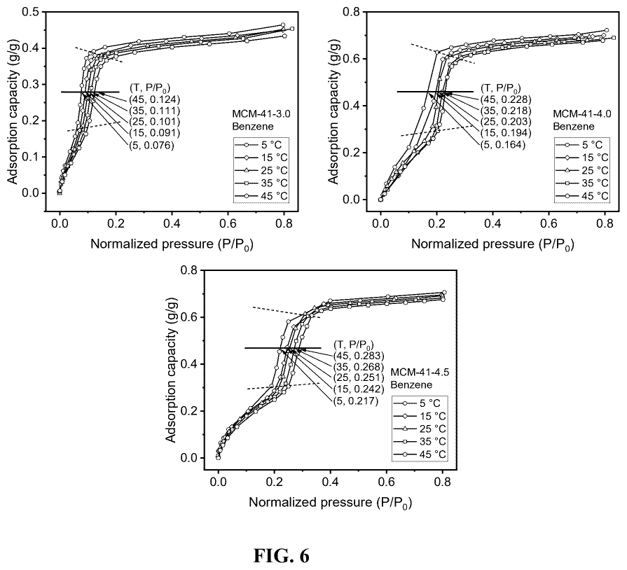

The normalized static adsorption isotherm is obtained by dividing each pressure point on the static adsorption isotherms by the saturated vapor pressure at the corresponding temperature, as shown in FIG. 6. According to the Kelvin equation, the adsorption of gas molecules on a porous material results in the volume-filling adsorption in pores below a specific size. According to the normalized adsorption isotherm, the corresponding relative pressure range is obtained when the volume-filling adsorption forms in each model adsorption material, the intermediate value of the relative pressure range is taken as a critical relative pressure point (P_{C}/P₀), and correlate the critical relative pressure point with the intermediate value of the pore size distribution of the model adsorption material, then take the pore size as a critical pore size (D_{C}) at which the volume-filling adsorption can form at the relative pressure point P_{C}/P₀. From the adsorption isotherms of the three model adsorption materials (pore sizes of 3.0 nm, 4.0 nm, and 4.5 nm, respectively) after normalization at multiple temperatures (5° C., 15° C., 25° C., 35° C., and 45° C.), the intermediate point (critical relative pressure) of the stage of rapid rise corresponding to the formation of volume-filling adsorption is determined, as shown in Table 1.

TABLE 1
Relative pressure (P_{C}/P₀) at the intermediate point
of the rapid rise phase during volume-filling adsorption
on the normalized benzene adsorption isotherm.

| | 5° C. | 15° C. | 25° C. | 35° C. | 45° C. |
|---|---|---|---|---|---|
| MCM-41-3.0 | 0.076 | 0.091 | 0.101 | 0.111 | 0.124 |
| MCM-41-4.0 | 0.164 | 0.194 | 0.203 | 0.218 | 0.228 |
| MCM-41-4.5 | 0.217 | 0.242 | 0.251 | 0.268 | 0.283 |
| Saturated vapor | 49.58 | 79.03 | 127.61 | 198.63 | 299.2 |
| pressure (P₀) | mbar | mbar | mbar | mbar | mbar |

According to the Kelvin equation, the adsorption of gas molecules on a porous material results in the volume-filling adsorption in pores below a specific size. It can be found that at the same pore size, the corresponding relative pressure required for volume-filling adsorption becomes greater as the adsorption temperature increases, and there is a correlation between the critical relative pressure P_{C}/P₀ and the corresponding adsorption temperature T. Under the same adsorption temperature, the larger the pore size of the model adsorption material, the greater the corresponding relative pressure required for volume-filling adsorption, and there is a correlation between the relative pressure and the corresponding critical pore size. By matching the critical relative pressure at various temperatures in the same pore size with the adsorption temperature, the linear relationship equation between the critical relative pressure (P_{C}/P₀) and the adsorption temperature (T) at a specific pore size can be obtained by linear fitting:

$${P}_{C} / {P}_{0} = {k}_{P} \times T + {d}_{P} , \qquad Equation 1 ;$$

where,
P_{C}/P₀ is the critical relative pressure of the critical pressure P_{C} with respect to the saturated vapor pressure P₀ at the corresponding adsorption temperature;
T is the adsorption temperature, and the unit is ° C.;
k_{P} is the slope of the linear relationship between relative pressure and adsorption temperature;
d_{P} is the value of P_{C}/P₀ when the relative pressure approaches 0 in the linear relationship;

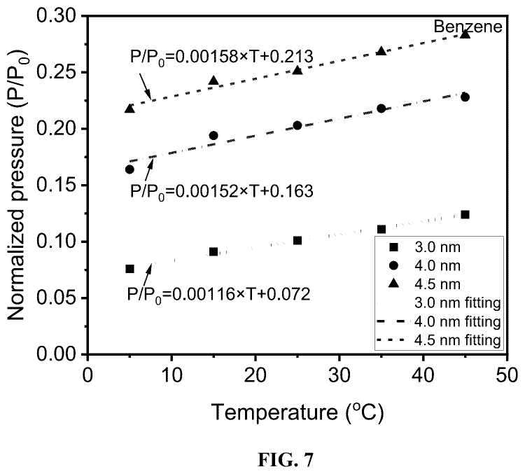

Based on the adsorption isotherms at different adsorption temperatures in the same pore size, a good linear relationship is found between the critical relative pressure of the adsorption isotherms at various temperatures and the adsorption temperature in the same pore size by correlating the intermediate point (critical relative pressure P_{C}/P₀) of the rapid rising stage corresponding to the volume-filling adsorption at different adsorption temperatures to the temperature T and performing linear fitting. The linear relationship equations between the critical relative pressure (P_{C}/P₀) and the adsorption temperature (T) in pores of different sizes are obtained. The linear fitting results are shown in FIG. 7. The linear relationship equations are as follows:
at 3.0 nm, P_{C}/P₀=0.00116×T+0.072;
at 4.0 nm, P_{C}/P₀=0.00152×T+0.163;
at 4.5 nm, P_{C}/P₀=0.00158×T+0.213.

By comparing the linear relationship equations between the critical relative pressure (P_{C}/P₀) and the adsorption temperature (T) at three pore sizes, it can be found that the coefficients k_{P} and d_{P} of the linear relationship equation P_{C}/P₀=k_{P}×T+d_{P} show certain differences in different pore sizes, as shown in Table 2.

TABLE 2
The coefficients k_{P} and d_{P} of the equation (Equation 1), which
express the linear relationship between the critical relative pressure
(P_{C}/P₀) and the adsorption temperature (T) of the volume-filling
adsorption of benzene in the pores of different sizes.

| Pore size | Coefficient k_{P} | Coefficient d_{P} |
|---|---|---|
| 3.0 nm | 0.00116 | 0.072 |
| 4.0 nm | 0.00152 | 0.163 |
| 4.5 nm | 0.00158 | 0.213 |

According to the linear relationship between the critical relative pressure (P_{C}/P₀) and the adsorption temperature (T) in multiple pore sizes, the coefficients k_{P} and d_{P} of the linear equations change with the pore size D_{C} of the materials, and the influence of the pore size D_{C} on the critical relative pressure (P_{C}/P₀) is obtained. The matching relationship equation for the critical relative pressure (P_{C}/P₀) of volume-filling adsorption changes with adsorption temperature T and pore size D_{C} can be obtained through linear fitting:

$${P}_{C} / {P}_{0} = f ( {D}_{C} ) \times T + ℊ ( {D}_{C} ) = ( {k}_{P 1} \times {D}_{C} + {k}_{P 0} ) \times T + ( {d}_{P 1} \times {D}_{C} + {d}_{P 0} ) , \qquad Equation 2 ;$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
D_{C} is the critical pore size, which can form volume-filling adsorption when the relative pressure is P_{C}/P₀, and the unit is nm;
k_{P1} and k_{P0} are the slope and intercept of the linear relationship equation between k_{P} and critical pore size D_{C}, respectively;
d_{P1} and d_{P0} are the slope and intercept of the linear relationship equation between d_{P} and critical pore size D_{C}, respectively;

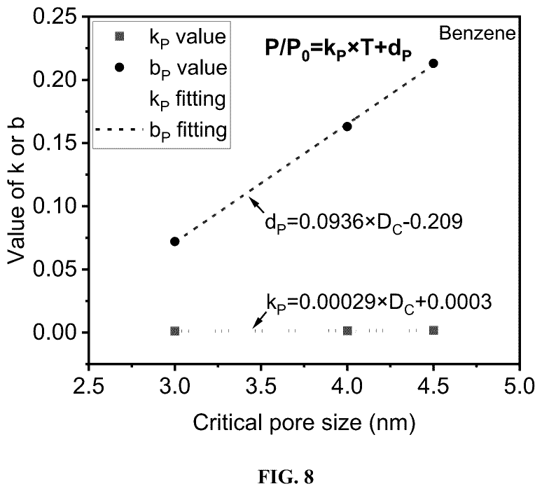

The matching relationship between the critical relative pressure P_{C}/P₀ and the critical pore size D_{C} for volume-filling adsorption at different adsorption temperatures T can be determined using this equation. By linear fitting the coefficients k_{P} and d_{P} in the linear relationship equation between the critical relative pressure (P_{C}/P₀) and the adsorption temperature (T) in three different pore sizes (3.0 nm, 4.0 nm, and 4.5 nm) with respect to their respective pore sizes (3.0 nm, 4.0 nm, 4.5 nm), the linear relationship equations k_{P}=0.00029×D_{C}+0.0003 and d_{P}=0.0094×D_{C}−0.209 for the coefficients k_{P} and d_{P} with changes in the pore size D_{C} are obtained, as shown in FIG. 8. Thus, the matching relationship equations for the critical relative pressure of volume-filling adsorption (P_{C}/P₀) with changes in adsorption temperature T and pore size D_{C} are obtained:

$${P}_{C} / {P}_{0} = ( 0.00029 \times {D}_{C} + 0.0003 ) \times T + ( 0.0094 \times {D}_{C} - 0.2 \; 09 ) , \qquad Equation 2.1 ;$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
D_{C} is the critical pore size, which can form volume-filling adsorption when the relative pressure is P_{C}/P₀, and the unit is nm;

By utilizing this equation, the matching relationship between the critical relative pressure P_{C}/P₀ and the critical pore size D_{C} for volume-filling adsorption at different adsorption temperatures T can be determined, and the matching relationship between the critical pore size D_{C} and the adsorption temperature T under different relative pressures P_{C}/P₀ can be determined.

The Equation 2 is utilized to obtain the matching relationship equation between the critical pore size D_{C} and the adsorption temperature T for volume-filling adsorption when the relative pressure P_{C}/P₀ is different:

$${D}_{C} = ( {P}_{C} / {P}_{0} - {k}_{P 0} \times T - {d}_{P 0} ) / ( {k}_{P 1} \times T + {d}_{P 1} ) , \qquad Equation 3 ;$$

where D_{C}, P_{C}/P₀, T, k_{P1}, k_{P0}, d_{P1} and d_{P0} denote the same meaning as in Equation 2.

Through Equation 3, the critical pore size D_{C} that can form volume-filling adsorption under different adsorption conditions (adsorption temperature T, and relative pressure P/P₀) can be determined.

With the obtained equation (Equation 2.1) combined with the method in Equation 3, the matching relationship between the critical pore size D_{C} at which volume-filling adsorption forms and the adsorption temperature T for a specific critical relative pressure P_{C}/P₀ can be obtained:

$${D}_{C} = ( {P}_{C} / {P}_{0} - 0.0003 \times T + 0.2 \; 09 ) / ( 0.00029 \times T + 0.09 \; 36 ) , \qquad Equation 3.1 ;$$

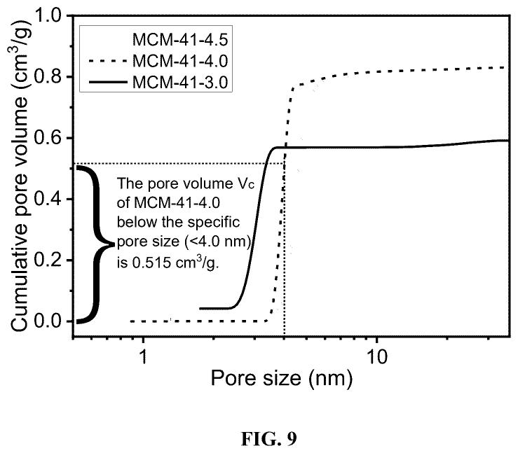

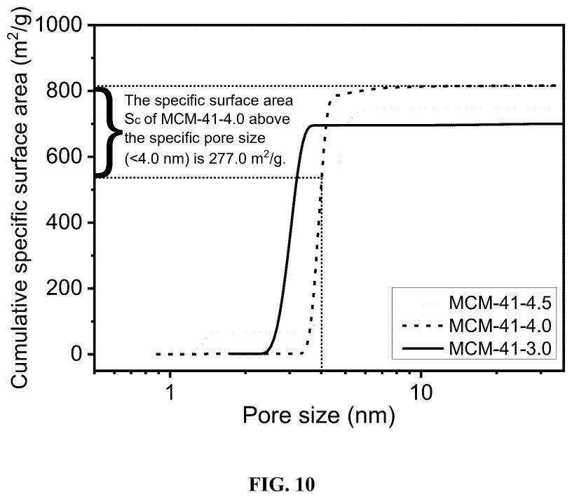

This equation can be utilized to calculate the critical pore size D_{C} that can undergo volume-filling adsorption corresponding to different critical relative pressures P_{C}/P₀ under different adsorption temperatures T. The critical pore size D_{C} is taken as the demarcation point, according to the results of pore structure test, the pore volume V_{C} of the pores below the critical pore size D_{C} and the specific surface area S_{C} of the pores above the critical pore size D_{C} for the model adsorption material are obtained, respectively. According to Equation 3.1, combined with the pore structure parameters of the model adsorption materials, the pore volume V_{C} corresponding to pores smaller than the critical pore size and the specific surface area S_{C} corresponding to pores larger than the critical pore size can be determined for any given critical pore diameter Dc. In which the pore volume below a specific size can be obtained through cumulative pore volume, as shown in FIG. 9; the specific surface area above a specific size can be obtained through cumulative specific surface area, as shown in FIG. 10.

According to the Kelvin equation, the adsorption of gas molecules on a porous material results in the volume-filling adsorption in pores below a specific size. Since volume-filling adsorption follows a filling mechanism, the adsorption capacity in this part is related to the density and the pore volume where volume-filling adsorption forms. Pores where volume-filling adsorption does not form are in a surface-covering mechanism with single-layer or multi-layer adsorption, and the adsorption capacity in this part is related to the corresponding specific surface area.

Based on the contribution of the pore volume V_{C} of the pores where volume-filling adsorption forms and the specific surface area S_{C} of the pores where surface-covering adsorption forms to the VOCs adsorption capacity, respectively, and by introducing the pore size, relative pressure and adsorption temperature of different model adsorption materials as parameters into the adsorption capacity prediction equation, the across-temperature VOCs adsorption capacity prediction equation is obtained, which enables the adsorption isotherms prediction to be extended to different adsorption temperatures. The quantity of adsorbed VOCs Q, pore volume V_{C}, and specific surface area S_{C} satisfy the across-temperature VOCs adsorption capacity prediction equation, namely Equation 4:

$$Q = a \times {V}_{C} + b \times {S}_{C} = f ( {D}_{A V} , P / {P}_{0} , T ) \times {V}_{C} + ℊ ( {D}_{A S} , P / {P}_{0} , T ) \times {S}_{C} ; \qquad Equation 4$$

in Equation 4, Q is the quantity of adsorbed VOCs per unit mass of adsorption material, and the unit is g/g;
V_{C} is the pore volume of the pores below the critical pore size, that is, the critical pore volume, and the unit is cm³/g;
S_{C} is the specific surface area of the pores above the critical pore size, that is, the critical specific surface area, and the unit is m²/g;
D_{AV} is the average pore size of the pores where volume-filling adsorption forms, and the unit is nm; where D_{AV}=AV_{C}/(S−S_{C}), S is the total specific surface area, and the unit is m²/g;
D_{AS} is the average pore size of the pores where surface-covering adsorption forms, and the unit is nm; where D_{AS}=4 (V−V_{C})/−S_{C}, V is the total pore volume, and the unit is cm³/g;
T is the adsorption temperature, and the unit is ° C.;
P/P₀ is any relative pressure point on the adsorption isotherm normalized to the saturated vapor pressure at the corresponding temperature;
P₀ is the saturated vapor pressure of VOCs at the corresponding adsorption temperature T, and the unit is mbar;
a is the coefficient of the volume-filling adsorption, that is, the adsorption capacity of VOCs per unit pore volume, and the unit is g/cm³, where a=f(D_{AV}, P/P₀, T) denotes that the coefficient a is the function of the pore size D_{AV}, the relative pressure P/P₀ and the adsorption temperature T;
b is the coefficient of the surface-covering adsorption, that is, the adsorption capacity of VOCs per unit specific surface area, and the unit is g/m², where b=f(D_{AS}, P/P₀, T) denotes that the coefficient b is the function of the pore size D_{AS}, the relative pressure P/P₀ and the adsorption temperature T.

The static adsorption of benzene on a series of model adsorption materials is a typical type IV adsorption isotherm, which can be roughly divided into three stages: in the initial stage of adsorption, with the increase of pressure, the adsorption capacity rapidly reaches a plateau and then increases slowly, which is attributed to the process of benzene molecules gradually forming monolayers or multilayers on the mesoporous surface. In the intermediate stage of adsorption, the adsorption capacity of benzene rapidly rises on the isotherm, which is caused by capillary coagulation forming in concentrated pores. In the third stage of adsorption, the isotherm reaches the second plateau, and the adsorption capacity increases slowly, which is mainly due to the slight increase of adsorption capacity due to the rearrangement of benzene molecules adsorbed in the pores in a filling way.

Calculation method of coefficient (a) of volume-filling adsorption:

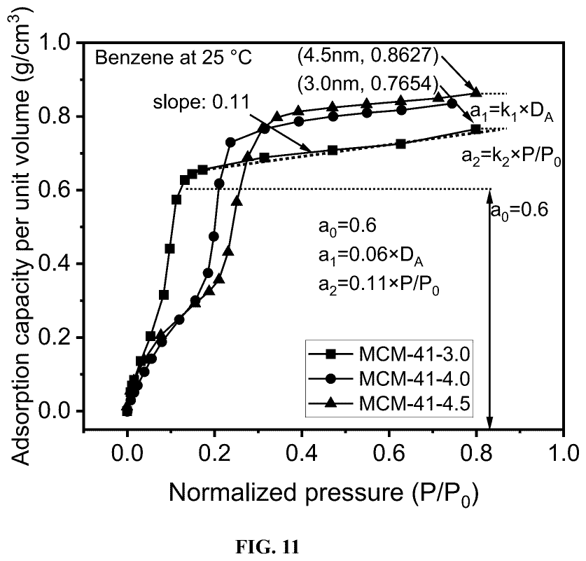

By dividing the adsorption capacity at each relative pressure point on the adsorption isotherm of the model adsorption material by the total pore volume, the trend for changes in the volume-filling adsorption coefficient (a=Q/V) with the relative pressure can be obtained, as shown in FIG. 11. In the volume-filling adsorption coefficient (a), a component not affected by the relative pressure and the pore size is set to do, a part affected by the pore size is set to a₁=f(D_{AV}), a part affected by the relative pressure is set to a₂=f(P/P₀), a part affected by the adsorption temperature is set to a₂=f(T), and a=a₀+a₁+a₂+a₃. Therefore, the volume-filling adsorption coefficient a=a₀+f(D_{AV})+f(P/P₀)+f(T).

It can be observed that in the third stage of the adsorption isotherm, which corresponds to the high-pressure region of the adsorption isotherm, the volume-filling adsorption is basically completed. Also, with the increase of relative pressure, the coefficient (a) of volume-filling adsorption shows a slightly increasing trend. This is mainly attributed to the fact that VOCs molecules in volume-filling adsorption can undergo molecular rearrangement with the increase of relative pressure, resulting in a slight increase in the coefficient (a) of volume-filling adsorption, while the increase in the coefficient (a) of volume-filling adsorption with different pore sizes is the same amplitude, i.e. a slope of 0.11, thus, the change in coefficient a caused by relative pressure is a₂=0.11×P/P₀, as shown in FIG. 11.

In the high-pressure region of the third stage adsorption isotherm, under the same relative pressure, the coefficient (a) of volume-filling adsorption corresponding to different pore sizes also has certain differences, as shown in FIG. 11, so the change of coefficient a caused by the difference in pore sizes is a₁=0.06×D_{AV}. The value of the part not affected by relative pressure and pore size is a₀=0.6, as shown in FIG. 11.

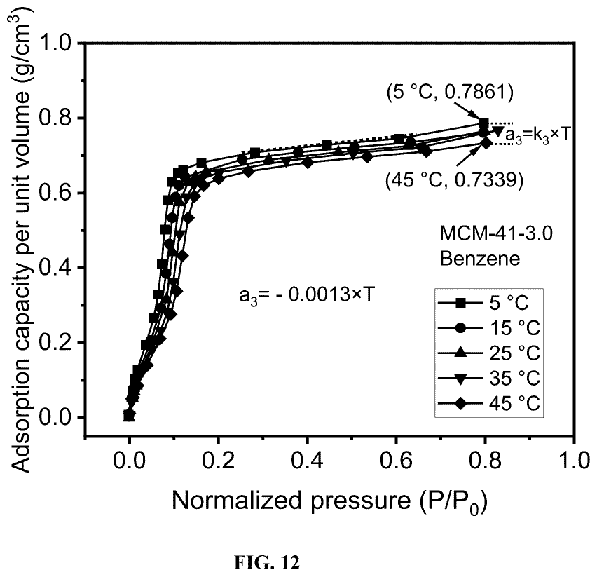

In the high-pressure region of the third stage adsorption isotherm, in the same pore size, the coefficient (a) of volume-filling adsorption corresponding to different adsorption temperatures also has certain differences, as shown in FIG. 12. With the increase of adsorption temperature, the density of benzene adsorbed per unit pore volume will decrease, resulting in a regular change of coefficient a. The change of coefficient a caused by the difference in adsorption temperature is @3=−0.0013× T, as shown in FIG. 12.

According to the high-pressure region after the formation of volume-filling adsorption in the adsorption isotherm, combined with the influence of the difference in pore size and adsorption temperature among different model adsorption materials on the adsorption isotherm, the calculation equation of the coefficient (a) of volume-filling adsorption is obtained:

$$a = 0.6 + 0.06 \times {D}_{A V} + 0.11 \times P / {P}_{0} - 0.0013 \times T$$

where D_{AV} is the average pore size of the pores where volume-filling adsorption forms, and the unit is nm; where D_{AV}=4V_{C}/(S−S_{C}), S is the total specific surface area, and the unit is m²/g;
S_{C} is the specific surface area of the pores above the critical pore size, that is, the critical specific surface area, and the unit is m²/g;
P/P₀ is any relative pressure point on the adsorption isotherm normalized to the saturated vapor pressure at the corresponding temperature;

Calculation method of the coefficient (b) of surface-covering adsorption:

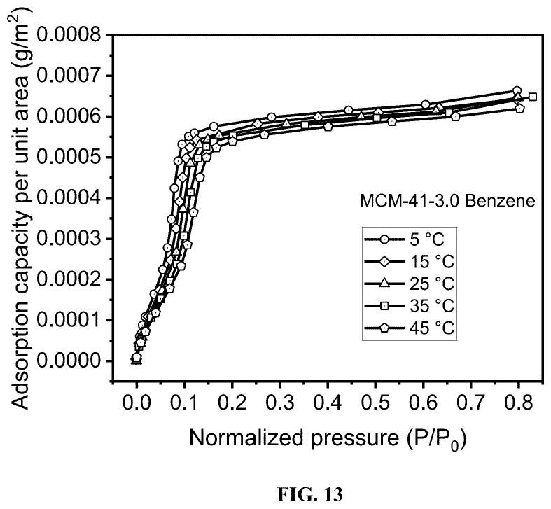

By dividing the adsorption capacity at each relative pressure point on the adsorption isotherm of the model adsorption material by the total surface area, the trend for changes in the surface-covering adsorption coefficient (b=Q/S) with the relative pressure can be obtained, as shown in FIG. 13. In the adsorption isotherm in the low-pressure region, the adsorption capacity increases slowly, which is a process of gradual formation of single-layer or multi-layer surface-covering adsorption. In this state, the volume-filling adsorption has not yet begun, so the trend of this state can be used to obtain the relationship between the coefficient b and the relative pressure P/P₀.

In the low-pressure region of the first stage adsorption isotherm, the equation (b=k_{b} XP/P₀+d_{b}) of the coefficient (b) of different pore sizes can be obtained by linearly fitting the adsorption isotherm in the low-pressure region, where d_{b} is the intercept and k_{b} is the slope. Both d_{b} and k_{b} are affected by pore size and adsorption temperature.

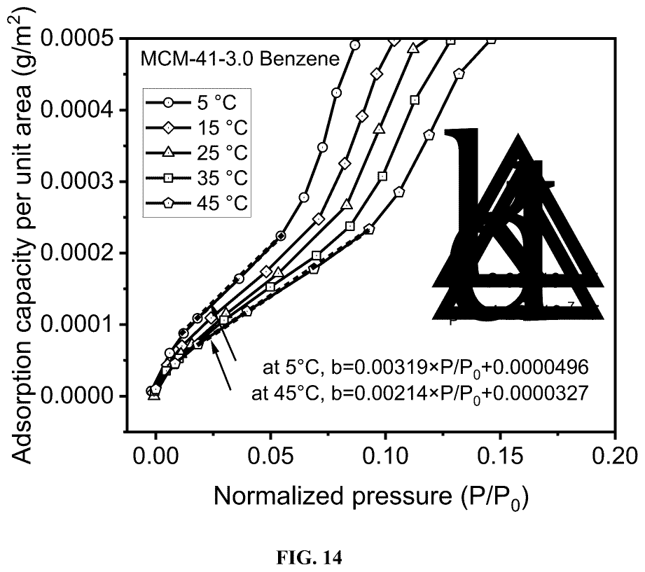

For the MCM-41-3.0 model adsorption material, when the adsorption temperature is 5° C., the linear fitting result of the coefficient (b) of surface-covering adsorption is b=0.00319×P/P₀+0.0000496; when the adsorption temperature is 45° C., the linear fitting result of the coefficient (b) of surface-covering adsorption is b=0.00214×P/P₀+0.0000327, as shown in FIG. 14.

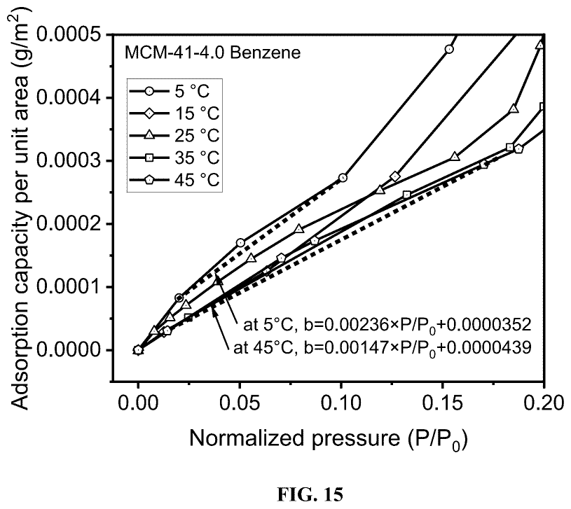

For the MCM-41-4.0 model adsorption material, when the adsorption temperature is 5° C., the linear fitting result of the coefficient (b) of surface-covering adsorption is b=0.00236×P/P₀+0.0000352; when the adsorption temperature is 45° C., the linear fitting result of the coefficient (b) of surface-covering adsorption is b=0.00147×P/P₀+0.0000439, as shown in FIG. 15.

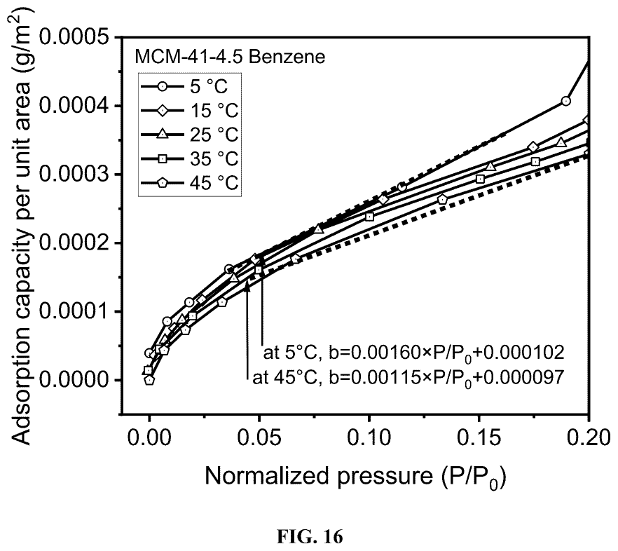

For the MCM-41-4.5 model adsorption material, when the adsorption temperature is 5° C., the linear fitting result of the coefficient (b) of surface-covering adsorption is b=0.00160×P/P₀+0.000102; when the adsorption temperature is 45° C., the linear fitting result of the coefficient (b) of surface-covering adsorption is b=0.00115×P/P₀+0.000097, as shown in FIG. 16.

Combined with MCM-41-3.0, MCM-41-4.0 and MCM-41-4.5 three model adsorption materials, in the first stage of the adsorption isotherm, by linear fitting of the adsorption isotherms in the low-pressure region, the equation (b=k_{b}×P/P₀+d_{b}) of different adsorption temperatures and different pore size coefficients (b) is obtained. It can be found that the intercept d_{b} and slope k_{b} in the equation are affected by pore size and adsorption temperature. At 5° C. and 45° C., the values of intercept d_{b} and slope k_{b} of the coefficient (b) of surface-covering adsorption equation for three model adsorption materials with the most probable pore sizes of 3.0 nm, 4.0 nm and 4.5 nm are shown in Table 3.

TABLE 3
Values of intercept d_{b} and slope k_{b} of the coefficient
(b) of surface-covering adsorption equation for three
model adsorption materials with the most probable pore
sizes of 3.0 nm, 4.0 nm and 4.5 nm at 5° C. and 45° C.

| Pore size | k_{b} at 5° C. | d_{b} at 5° C. | k_{b} at 45° C. | d_{b} at 45° C. |
|---|---|---|---|---|
| 3.0 nm | 0.00319 | 0.0000496 | 0.00214 | 0.0000327 |
| 4.0 nm | 0.00236 | 0.0000352 | 0.00147 | 0.0000439 |
| 4.5 nm | 0.00160 | 0.0001020 | 0.00115 | 0.0000970 |

It can be found that the value of the slope k_{b} of the coefficient (b) of surface-covering adsorption equation decreases with the increase of the pore size of the material. Assuming that the pore size is linearly related to the slope k_{b}, the slope is expressed by the equation k_{P}=kₖ×D_{AS}+dₖ, where D_{AS} (D_{AS}=4 (V−V_{C})/S_{C}) is the average pore size of the pores where the surface-covering adsorption forms.

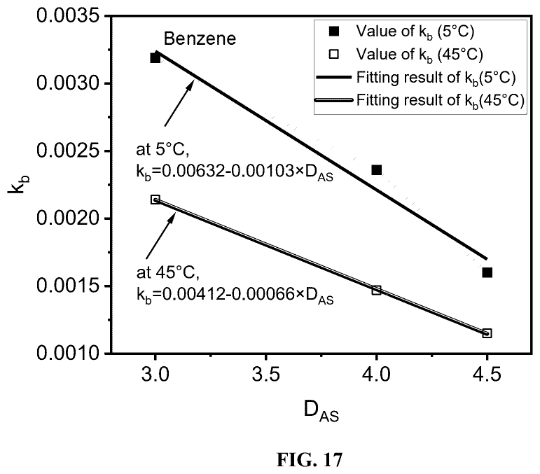

According to the change trend of slope k_{P} in three model adsorption materials with pore sizes of 3.0 nm, 4.0 nm and 4.5 nm at 5° C., the equation k_{b}=0.00632−0.00103× D_{AS} can be obtained, where D_{AS} (D_{AS}=4 (V−V_{C})/S_{C}) is the average pore size of the pores where the surface-covering adsorption forms, as shown in FIG. 17.

According to the change trend of slope k_{P} in three model adsorption materials with pore sizes of 3.0 nm, 4.0 nm and 4.5 nm at 45° C., the equation k_{P}=0.00412−0.00066× D_{AS} can be obtained, where D_{AS} (D_{AS}=4 (V−V_{C})/S_{C}) is the average pore size of the pores where the surface-covering adsorption forms, as shown in FIG. 17.

From FIG. 17, it can be seen that the slope k_{P} of the surface-covering adsorption coefficient b corresponding to the adsorption temperature T has an important influence, such as k_{b}=0.00632-0.00103× D_{AS} at 5° C. and k_{P}=0.00412-0.00066×D_{AS} at 45° C. This is mainly due to the fact that with the increase of adsorption temperature, the adsorption force of the pore wall of the adsorption material on the VOCs molecules is weakened, resulting in a decrease in the quantity of benzene adsorbed per unit surface area, so the coefficient b also shows regular changes.

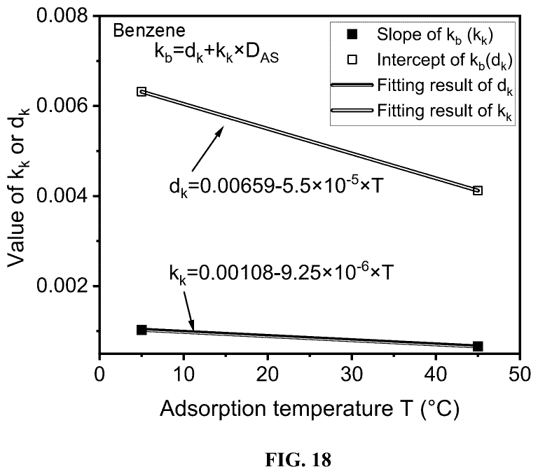

The coefficients of the equation with slope k_{b} at various temperatures are linearly fitted with the adsorption temperature T (5° C. and 45° C.), and the regularity equation of the coefficient of the equation of slope k_{P} with changes in temperature and pore size is obtained: k_{b}=(0.00659−5.5×10⁻⁵×T)−(0.00108−9.25× 10⁻⁶×T)× D_{AS}, as shown in FIG. 18.

The values of the intercept d_{b} of the coefficient (b) of surface-covering adsorption equation at different pore sizes and adsorption temperatures are shown in Table 3. The average value of d_{b} at 5° C. is about 0.00006. At the same pore size, there are some differences in the intercept d_{b} of the coefficient (b) of surface-covering adsorption corresponding to different adsorption temperatures. As shown in FIG. 14, for the 3.0 nm pore, the intercept d_{b} of the coefficient b is 0.0000496 at 5° C., and the intercept d_{b} of the coefficient b is 0.0000327 at 45° C. Therefore, the increment of the intercept d_{P} of the coefficient b caused by the adsorption temperature T can be obtained as _{Δ}d_{b}=−4.23×10⁻⁷×T. Therefore, the intercept of the coefficient b of surface-covering adsorption is d_{b}=0.00006−4.23×10⁻⁷×T.

Therefore, by introducing the pore size D_{AS}, relative pressure P/P₀ and adsorption temperature T as variables into the coefficient b, the equation of the coefficient b of surface-covering adsorption in the adsorption process of benzene at various temperatures is:

$$b = ( ( 0.00659 - 5.5 \times 1 {0}^{- 5} \times T ) - ( 0.00108 - 9.25 \times 1 {0}^{- 6} \times T ) \times {D}_{A S} \times P / {P}_{0} + ( 0.00006 - 4.23 \times 1 {0}^{- 7} \times T ) ; \qquad Equation 6.1$$

In Equation 6.1, b is the coefficient of the surface-covering adsorption, that is, the adsorption capacity of VOCs per unit specific surface area, and the unit is g/m², where b=f(D_{AS}, P/P₀, T) denotes that the coefficient b is the function of the pore size D_{AS}, the relative pressure P/P₀ and the adsorption temperature T.

D_{AS} is the average pore size of the pores where surface-covering adsorption forms, and the unit is nm;
where D_{AS}=4 (V−V_{C})/−S_{C}, V is the total pore volume, and the unit is cm³/g;
P/P₀ is any relative pressure point on the adsorption isotherm normalized to the saturated vapor pressure at the corresponding temperature;
T is the adsorption temperature, and the unit is ° C.

In summary, in the present disclosure, the pore size D, relative partial pressure P_{C}/P₀ and adsorption temperature T are introduced into the VOCs adsorption capacity prediction equation Q=a×V_{C}+b×S_{C} as parameters, and the regularity equations for changes in the volume-filling adsorption coefficient a and surface-covering adsorption coefficient b with pore size D, relative partial pressure P_{C}/P₀ and adsorption temperature T are obtained. Thus, the across-temperature adsorption capacity/isotherm prediction equation is derived. The equation for predicting the adsorption capacity/isotherm of benzene at various temperatures is obtained as follows:

$$Q = ( 0.6 + 0.06 \times {D}_{A S} + 0.11 \times P / {P}_{0} - 0.0013 \times T ) \times {V}_{C} + ( ( ( 0.006 \; 59 - 5.5 \times 1 {0}^{- 5} \times T ) - ( 0.00108 - 9.25 \times 1 {0}^{- 6} \times T ) \times {D}_{A S} \times P / {P}_{0} + ( 0.000 \; 06 - 4.23 \times 1 {0}^{- 7} \times T ) ) \times {S}_{C} ; \qquad Equation 4.1$$

in Equation 4.1, Q is the quantity of adsorbed VOCs per unit mass of adsorption material, and the unit is g/g;
V_{C} is the pore volume of the pore below the critical pore size, that is, the critical pore volume, and the unit is cm³/g;
S_{C} is the specific surface area of the pores above the critical pore size, that is, the critical specific surface area, and the unit is m²/g;
D_{AV} is the average pore size of the pores where volume-filling adsorption forms, and the unit is nm; where D_{AV}=AV_{C}/(S−S_{C}), S is the total specific surface area, and the unit is m²/g;
D_{AS} is the average pore size of the pores where surface-covering adsorption forms, and the unit is nm; where D_{AS}=4 (V−V_{C})/−S_{C}, V is the total pore volume, and the unit is cm³/g;
T is the adsorption temperature, and the unit is ° C.;
P/P₀ is any relative pressure point on the adsorption isotherm normalized to the saturated vapor pressure at the corresponding temperature;
P₀ is the saturated vapor pressure of VOCs at the corresponding adsorption temperature T, and the unit is mbar.

Through the same equation (Equation 4.1), the prediction of VOCs adsorption capacity and isotherms at various temperatures can be achieved based on the pore structure parameters of the model adsorption material. According to the matching relationship between D_{C} and T, P_{C}/P₀ (Equation 3.1) (D_{C}=(P_{C}/P₀−0.0003× T+0.209)/(0.00029×T+0.0936)), the corresponding critical pore diameter D_{C} that can undergo volume-filling adsorption is obtained for different adsorption temperatures T and different relative pressures P/P₀. In combination with the pore structure parameters of the model adsorption materials, the critical pore volume V_{C} and critical specific surface area S_{C} can be obtained for any given critical pore size Dc. The values of adsorption temperature T and relative pressure P/P₀ from the adsorption isotherm, along with their corresponding pore structure parameters (D_{AV}, D_{AS}, V_{C}, and S_{C}), are substituted into the adsorption capacity prediction equation. The prediction of adsorption isotherms at various temperatures is calculated, thereby achieving the prediction of adsorption capacity/isotherms across temperatures.

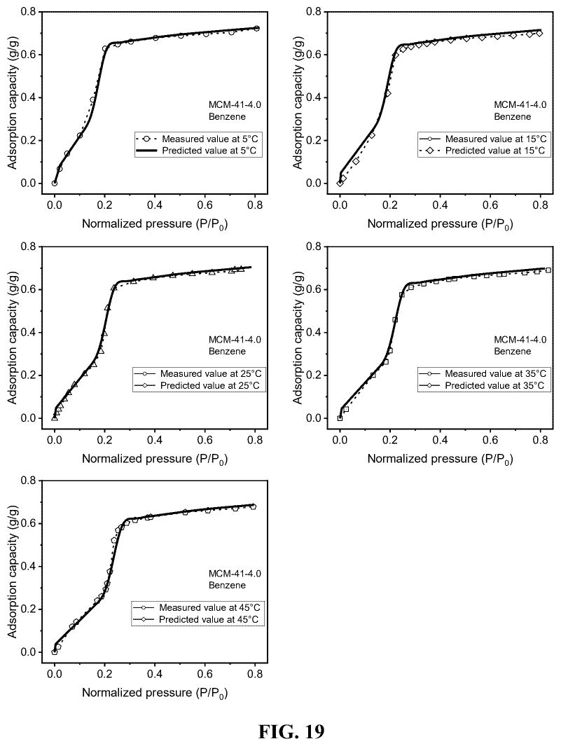

The same adsorption capacity prediction equation that across temperatures (Equation 4.1) is utilized. The pore structure parameters and adsorption temperature T (5° C., 15° C., 25° C., 35° C., and 45° C.) of MCM-41-4.0 are substituted into the equation to calculate the adsorption capacity of MCM-41-4.0 model adsorption material. At multiple adsorption temperatures, the adsorption capacity of benzene changes with relative pressure, that is, the predicted normalized adsorption isotherms. The predicted and measured normalized adsorption isotherms at different adsorption temperatures are shown in FIG. 19. It can be seen that the predicted normalized adsorption isotherms are in good agreement with the measured normalized adsorption isotherms obtained by experimental tests.

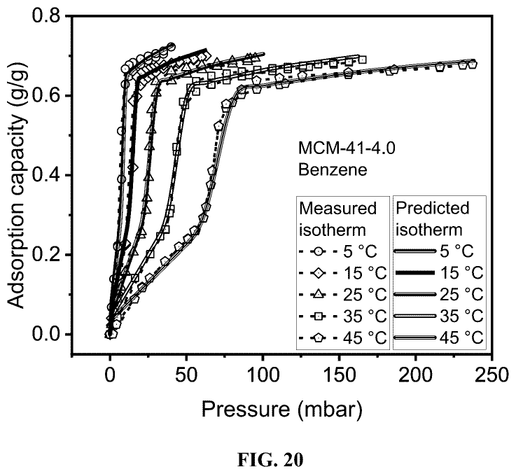

Based on the obtained across-temperature VOCs adsorption capacity prediction equation, through the pore structure parameters of the model adsorption material, the critical pore volume V_{C} and the critical specific surface area S_{C} corresponding to the critical pore size D_{C} under the corresponding adsorption conditions (adsorption temperature T, and relative pressure) are substituted into the equation as known data, and the trend of changes in adsorption capacity with relative pressure P/P₀ at different adsorption temperatures is determined. By multiplying the predicted relative pressure P/P₀ of the adsorption isotherms by the saturated vapor pressure P₀ (49.58 mbar, 79.03 mbar, 127.61 mbar, 198.63 mbar, and 299.2 mbar) at the corresponding temperature (5° C., 15° C., 25° C., 35° C., and 45° C.), the predicted adsorption isotherms before normalization at the corresponding adsorption temperature can be obtained. This achieves the prediction of VOCs adsorption capacities and isotherms at various temperatures using the same equation, as shown in FIG. 20.

This across-temperature VOCs adsorption capacity prediction equation derives a regularity equation for the critical pore size enabling volume-filling adsorption under varying adsorption conditions (temperature, and pressure) by exploring the changing laws of the critical pore size for volume-filling adsorption with adsorption temperature. Based on the pore volume of the pores with volume-filling and the specific surface area of the pores with surface-covering adsorption, the pressure and adsorption temperature related parameters (saturated vapor) are used as variables to obtain the across-temperature VOCs adsorption capacity prediction equation. According to this equation, the adsorption capacity and isotherms of VOCs at various temperatures can be predicted by the same equation based on the pore structure parameters of the adsorption materials, which has an important reference value for the development of VOCs adsorption materials and technologies.

### Embodiment 2

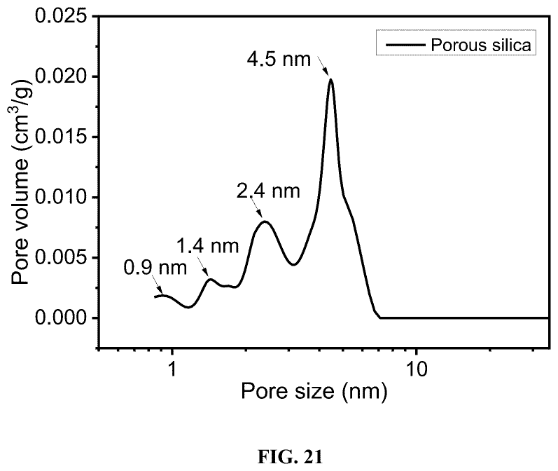

In order to further verify that the obtained adsorption capacity prediction equation can be applied to the prediction of adsorption capacity and adsorption isotherms of other conventional adsorption materials for specific VOCs, a porous silica material without a concentrated pore size distribution (as shown in FIG. 21) is employed as the adsorption material in this embodiment. The applicability of the equation to other adsorption materials without a concentrated pore size distribution is verified by using the benzene across-temperature adsorption capacity prediction equation obtained in Embodiment 1.

A commercial specific surface area and pore structure analyzer measures the pore structure parameters of the adsorption material, and obtains the pore structure parameters of the adsorption material through the DFT cylindrical pore calculation model. Based on the ternary matching relationship equation (Equation 3.1) among the critical pore size D_{C} that can undergo volume-filling adsorption, the critical relative pressure P_{C}/P₀ and the adsorption temperature T in Embodiment 1, combined with the obtained pore structure parameters of the adsorption material, according to the cumulative pore volume and the cumulative specific surface area with the change of the pore size, the critical pore volume V_{C} and the critical specific surface area S_{C} corresponding to the critical pore size D_{C} under the corresponding adsorption conditions (adsorption temperature T, and relative pressure P/P₀) are obtained.

The ternary matching relationship equation (Equation 3.1) among the critical pore size D_{C} for volume-filling adsorption, the critical relative pressure P_{C}/P₀ and the adsorption temperature T in Embodiment 1 is:

$${D}_{c} = ( {P}_{c} / {P}_{0} - 0.0003 \times T + 0.209 ) / ( 0.00029 \times T + 0.0936 ) , \qquad Equation 3.1 .$$

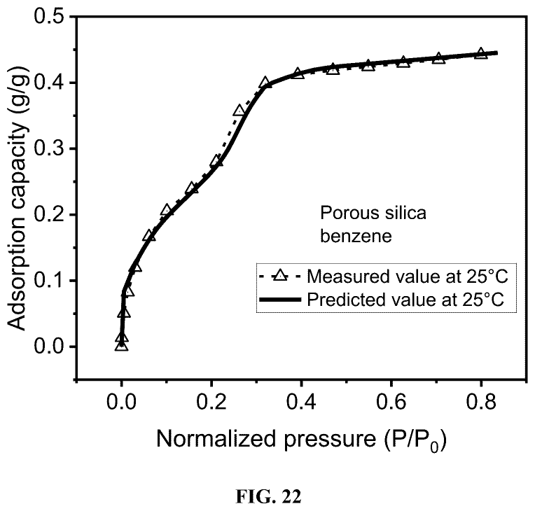

The parameters such as the critical pore volume V_{C} and the critical specific surface area S_{C} corresponding to the critical pore size D_{C} under the corresponding adsorption conditions are substituted into the benzene across-temperature adsorption capacity prediction equation (Equation 4.1) as known data, and the trend of changes in adsorption capacity with relative pressure at the corresponding adsorption temperature is determined, as shown in FIG. 22.

In Embodiment 1, the benzene across-temperature adsorption capacity prediction equation is:

$$Q = ( 0.6 + 0.06 \times {D}_{A V} + 0.11 \times P / {P}_{0} - 0.0013 \times T ) \times {V}_{C} + ( ( 0.00659 - 5.5 \times 1 {0}^{- 5} \times T ) - 0.00108 - 9.25 \times 1 {0}^{- 6} \times T ) \times {D}_{A S} ) \times P / {P}_{0} + ( 0.000 \; 06 - 4.23 \times 1 {0}^{- 7} \times T ) ) \times {S}_{C} ; \qquad Equation 4.1$$

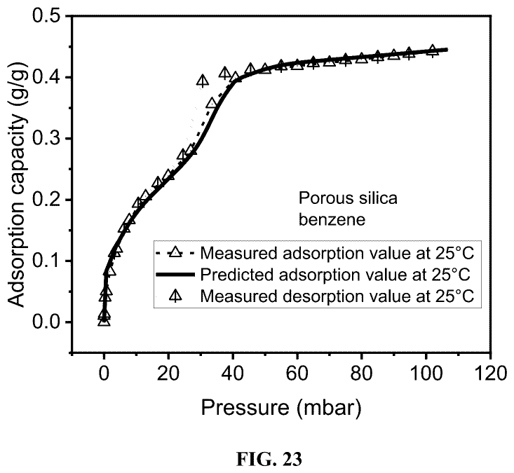

By multiplying the relative pressure P/P₀ of the predicted adsorption isotherms by the saturated vapor pressure P₀ (127.61 mbar) at the corresponding temperature (25° C.), the adsorption isotherms of benzene on the porous silica adsorption materials before normalization at 25° C. are calculated, which are the predicted adsorption isotherms, as shown in FIG. 23. FIG. 23 shows a comparison between predicted and measured adsorption isotherms for a porous silica material without a concentrated pore size distribution. It can be seen from FIG. 23 that the prediction method provided by the present disclosure is in good agreement with the adsorption isotherms obtained by the experimental tests.

It can be found that the method of the present disclosure is also applicable to the prediction of adsorption capacity and adsorption isotherms of specific VOCs for other adsorption materials without concentrated pore size distributions at different adsorption temperatures. The adsorption capacity prediction equation obtained by using the silica-based adsorption material in Embodiment 2 can be directly used to predict the adsorption capacity of other silica-based adsorption materials without a concentrated pore size distribution. Therefore, in the case that the composition of the material is similar to the surface properties, the obtained adsorption capacity prediction equation can be directly used to predict the adsorption capacity and adsorption isotherms of other adsorption materials at different adsorption temperatures. It shows that the VOCs adsorption capacity and the adsorption isotherm prediction method of the present disclosure have good generalizability.

### Embodiment 3

It can be determined from the derivation method of the adsorption capacity prediction equation that the VOCs adsorption capacity prediction method is not limited by the type of VOCs and has good generalizability. In order to further verify the generalizability of the adsorption capacity prediction method, acetone is employed as the adsorbate to test the adsorption isotherms of acetone on a series of model adsorption materials at multiple adsorption temperatures. Combined with the pore structure parameters, the equation suitable for the prediction of the adsorption capacity of acetone across the adsorption temperature is derived.

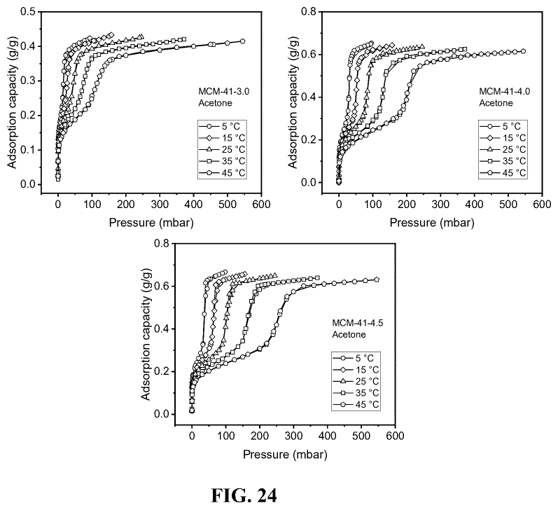

The ordered mesoporous silica MCM-41 materials with the most probable pore diameters of 3.0 nm, 4.0 nm and 4.5 nm in Embodiment 1 are used as model adsorption materials, as shown in FIG. 2, FIG. 3 and FIG. 4. The static adsorption isotherms of acetone on three model adsorption materials at 5° C., 15° C., 25° C., 35° C. and 45° C. are tested by the IGA, as shown in FIG. 24.

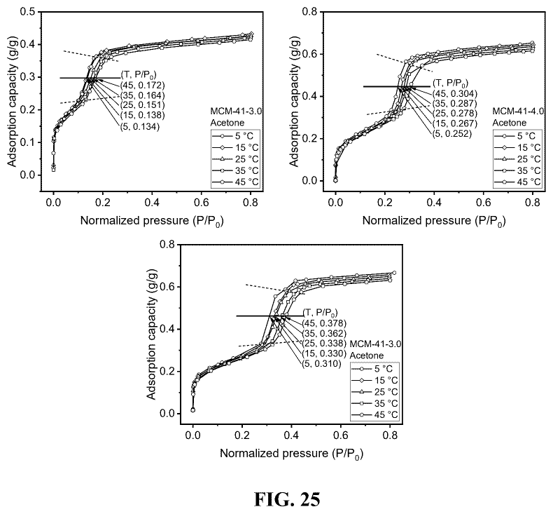

The normalized static adsorption isotherm is obtained by dividing each pressure point on the static adsorption isotherms by the saturated vapor pressure at the corresponding temperature, as shown in FIG. 25. From the adsorption isotherms of the three model adsorption materials (pore sizes of 3.0 nm, 4.0 nm, and 4.5 nm, respectively) after normalization at multiple temperatures (5° C., 15° C., 25° C., 35° C., and 45° C.), the intermediate point (critical relative pressure P_{C}/P₀) of the stage of rapid rise corresponding to the formation of volume-filling adsorption is determined, as shown in Table 4.

TABLE 4
Relative pressure (P_{C}/P₀) at the intermediate point
of the rapid rise phase during volume-filling adsorption
on the normalized acetone adsorption isotherm.

| | 5° C. | 15° C. | 25° C. | 35° C. | 45° C. |
|---|---|---|---|---|---|
| MCM-41-3.0 | 0.134 | 0.138 | 0.151 | 0.164 | 0.172 |
| MCM-41-4.0 | 0.252 | 0.267 | 0.278 | 0.287 | 0.304 |
| MCM-41-4.5 | 0.31 | 0.33 | 0.338 | 0.362 | 0.378 |
| Saturated vapor | 120.1 | 195.73 | 306.73 | 464.28 | 681.42 |
| pressure (P₀) | mbar | mbar | mbar | mbar | mbar |

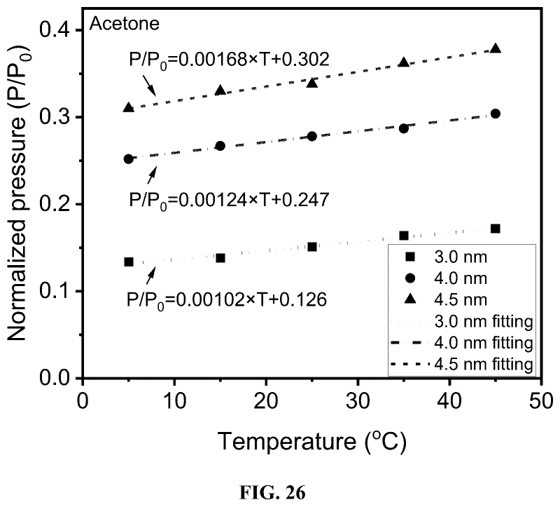

According to the method of Embodiment 1, by matching the critical relative pressure at various temperatures within the same pore size with the adsorption temperature, a linear relationship equation between the critical relative pressure (P_{C}/P₀) and the adsorption temperature (T) can be obtained for a specific pore size through linear fitting. The linear relationship equations between the critical relative pressure (P_{C}/P₀) and the adsorption temperature (T) in pores of different sizes are obtained. The linear fitting results are shown in FIG. 26. The linear relationship equations are as follows:
at 3.0 nm, P_{C}/P₀=0.00102×T+0.126;
at 4.0 nm, P_{C}/P₀=0.00124×T+0.247;
at 4.5 nm, P_{C}/P₀=0.00168×T+0.302.

By comparing the linear relationship equations between the critical relative pressure (P_{C}/P₀) and the adsorption temperature (T) at three pore sizes (3.0 nm, 4.0 nm, and 4.5 nm), it can be found that the coefficients k_{P} and d_{P} of the linear relationship equation P_{C}/P₀=k_{P}×T+d_{P} show certain differences in different pore sizes, as shown in Table 5.

TABLE 5
The coefficients k_{P} and d_{P} of the equation (Equation 1) between
the critical relative pressure (P_{C}/P₀) and the adsorption temperature
(T) for acetone adsorption by pores of different sizes

| Pore size | Coefficient k_{P} | Coefficient d_{P} |
|---|---|---|
| 3.0 nm | 0.00102 | 0.126 |
| 4.0 nm | 0.00124 | 0.247 |
| 4.5 nm | 0.00168 | 0.302 |

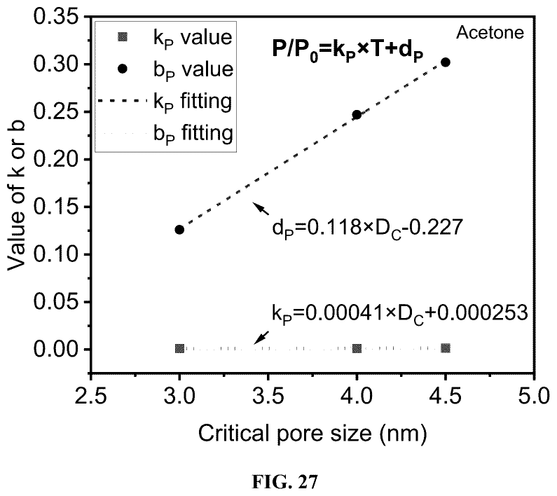

According to Equation 2, by linear fitting the coefficients k_{P} and d_{P} in the linear relationship equation between the critical relative pressure (P_{C}/P₀) and the adsorption temperature (T) in three different pore sizes with respect to their respective pore sizes (3.0 nm, 4.0 nm, and 4.5 nm), the linear relationship equations k_{P}=0.00041×D_{C}+0.000253 and d_{P}=0.118×D_{C}−0.227 for changes in the coefficients k_{P} and d_{P} with the pore size D_{C} are obtained, as shown in FIG. 27. Thus, the matching relationship equations for changes in the critical relative pressure (P_{C}/P₀) of volume-filling adsorption with adsorption temperature T and pore size D_{C} are obtained:

$${P}_{c} / {P}_{0} = ( 0.00041 \times {D}_{C} + 0.000253 ) \times T + ( 0.118 \times {D}_{C} - 0.227 ) ; \qquad Equation 22$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
D_{C} is the critical pore size, which can form volume-filling adsorption when the relative pressure is P_{C}/P₀, and the unit is nm;

The obtained equation (Equation 2) is utilized to combine with the method of Equation 3, the matching relationship equation between D_{C} with T, and P/P₀ can be obtained, that is, Equation 3.2:

$${D}_{C} = ( {P}_{C} / {P}_{0} - 0.000253 \times T + 0.227 ) / ( 0.00041 \times T + 0.1 \; 18 ) , \qquad Equation 3.2 ;$$

where P_{C}/P₀ is the critical relative pressure of the critical pressure P_{C} with respect to the saturated vapor pressure P₀ at the corresponding adsorption temperature;
T is the adsorption temperature, and the unit is ° C.;
D_{C} is the critical pore size, which can form volume-filling adsorption when the relative pressure is P_{C}/P₀, and the unit is nm.

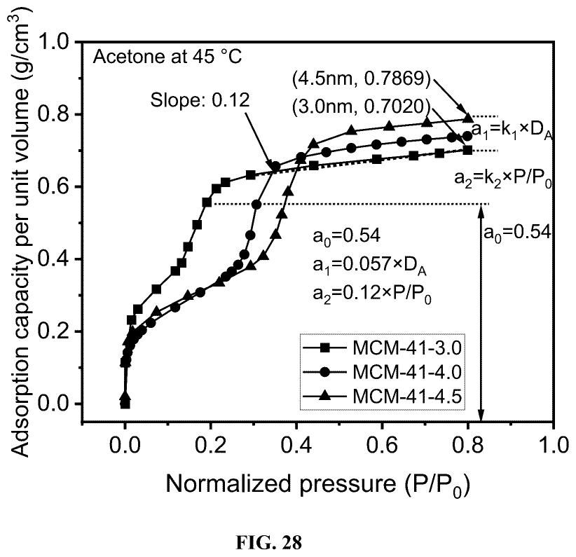

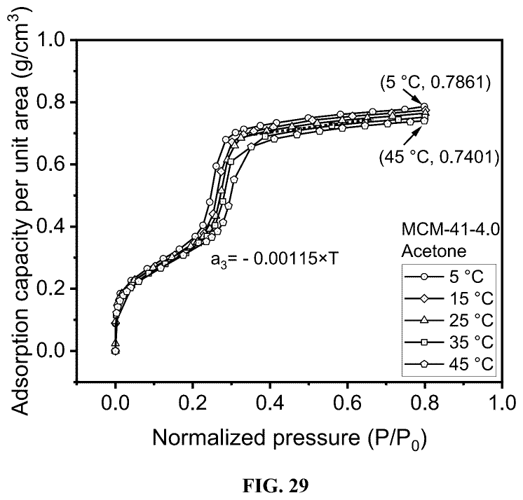

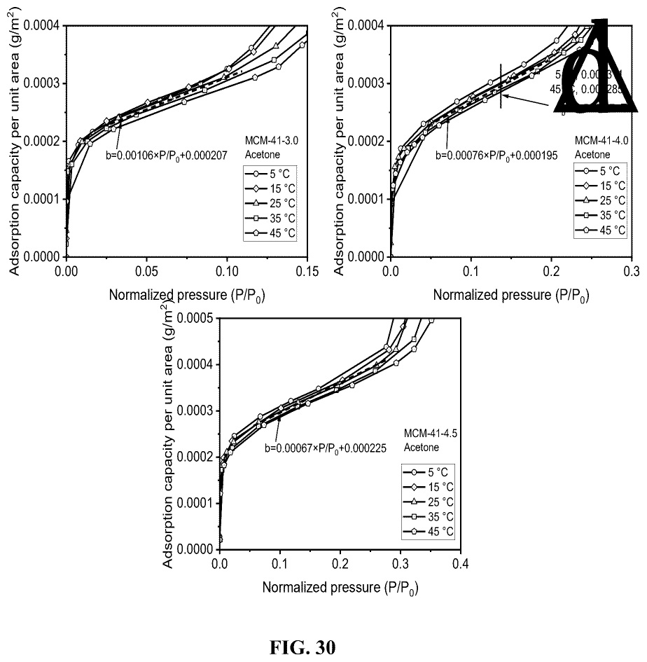

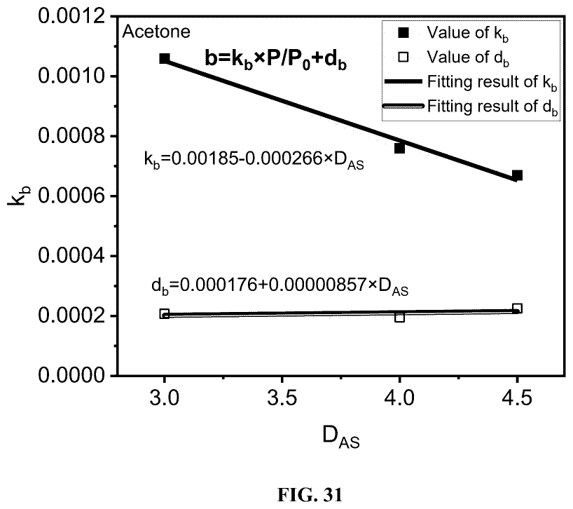

According to the method of Embodiment 1, by introducing pore size D, relative partial pressure P_{C}/P₀, and adsorption temperature T as parameters into the VOCs adsorption capacity prediction equation Q=a×V_{C}+b×S_{C}, the regularity equation for the changes in the coefficient a of volume-filling adsorption (as shown in FIGS. 28 and 29) and the coefficient b of surface-covering adsorption (as shown in FIGS. 30 and 31) of the acetone adsorption capacity prediction equation with pore size D, relative partial pressure P_{C}/P₀, and adsorption temperature T are obtained. When calculating adsorption coefficient b, analysis of FIG. 30 indicates that adsorption temperature has a minor effect on the slope k_{b} of b. Therefore, to simplify calculations, the slope values k_{b} of b from the adsorption isotherms at 25° C. for each model adsorption material are taken as the average values. The resulting equations for the coefficient a of volume-filling adsorption and the coefficient b of surface-covering adsorption are:

$$a = 0.5 + 0.057 \times {D}_{A V} + 0.12 \times P / {P}_{0} - 0.00115 \times T ;$$

$$b = ( 0.00185 - 0.000266 \times {D}_{A S} \times P / {P}_{0} + ( 0.000176 + 0.000008 \; 57 \times {D}_{A S} ) - 6.5 \times 1 {0}^{- 7} \times T ;$$

thus, the across-temperature adsorption capacity/isotherm prediction equation is derived. The equation for predicting the adsorption capacity/isotherm of acetone at various temperatures is obtained as follows:

$$Q = ( 0.5 + 0.057 \times {D}_{A V} + 0.12 \times P / {P}_{0} - 0.00115 \times T ) \times {V}_{C} + ( ( 0.00185 - 0.000266 \times {D}_{A S} ) \times P / {P}_{0} + ( 0.000176 + 0.00000857 \times {D}_{A S} ) - 6 \text{.5} \times {10}^{- 7} \times T ) \times {S}_{c} ; \qquad Equation 4.2$$

where Q, V_{C}, S_{C}, D_{AV}, D_{AS}, T, and P/P₀ denote the same meanings as in Equation 4.

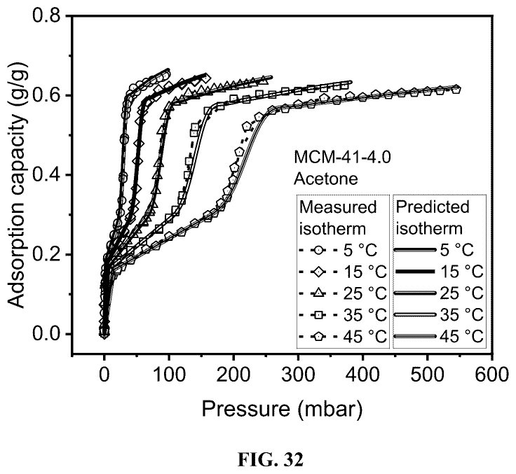

Based on the obtained acetone across-temperature adsorption capacity prediction equation (Equation 4.2), the adsorption temperature T, the relative pressure P/P₀ and the corresponding pore structure parameters (D_{AV}, D_{AS}, V_{C}, and S_{C}) can be substituted into the equation for predicting the adsorption capacity (Equation 4.2), and the trend of changes in the adsorption capacity with the relative pressure at different adsorption temperatures can be determined. By multiplying the relative pressure P/P₀ of the predicted adsorption isotherm by the saturated vapor pressure P₀ (120.1 mbar, 195.73 mbar, 306.73 mbar, 464.28 mbar, and 681.42 mbar) at the corresponding temperature (5° C., 15° C., 25° C., 35° C., and 45° C.), the predicted adsorption isotherm at the corresponding adsorption temperature can be obtained, as shown in FIG. 32, and the VOCs adsorption capacity and isotherms at various temperatures can be predicted by the same equation. FIG. 32 shows the predicted and measured adsorption isotherms at different adsorption temperatures. It can be seen from FIG. 32 that the prediction method provided by the present disclosure is in good agreement with the adsorption isotherms obtained by the experimental test. It can be found that the method of the present disclosure is also applicable to the derivation and prediction of the adsorption capacity and adsorption isotherm prediction equation of other VOCs (such as acetone) at different adsorption temperatures.

Collectively, by comparing with the adsorption capacity prediction equation of benzene in Embodiment 1, it can be found that the basic structure of the VOCs adsorption capacity prediction equation Q=a×V_{C}+b×S_{C} remains unchanged, that is, the adsorption of VOCs by porous materials includes two parts: volume-filling adsorption and surface-covering adsorption. By introducing adsorption temperature T, relative pressure P/P₀ and pore size D as variables, the influence of adsorption temperature difference can be effectively overcome, and the across-temperature prediction is achieved using the same equation. Due to the differences in saturated vapor pressure, molecular weight, molecular size, boiling point, polarity and other properties of different VOCs, the corresponding coefficients (a and b) of volume-filling adsorption and surface-covering adsorption will also be different. In general, utilizing the adsorption isotherm of the model adsorption material for specific VOCs and its pore structure parameters, the method of the present disclosure enables derivation of an across-temperature prediction equation for the adsorption capacity of those specific VOCs. It demonstrates that the across-temperature VOCs adsorption capacity/isotherm prediction method developed in the present disclosure exhibits good generalizability.

### Embodiment 4

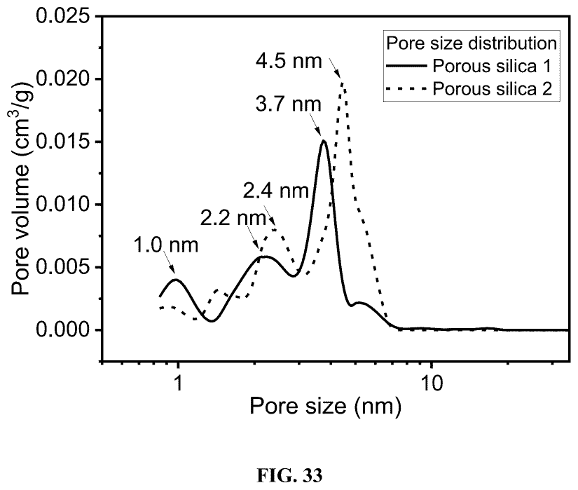

In order to further verify that the obtained adsorption capacity prediction equation can be applied to the prediction of adsorption capacity and adsorption isotherms of other conventional adsorption materials for specific VOCs, two kinds of porous silica materials without concentrated pore size distributions (as shown in FIG. 33) are employed as the adsorption materials in this embodiment. The applicability of the equation to other adsorption materials without a concentrated pore size distribution is verified by using the acetone across-temperature adsorption capacity prediction equation obtained in Embodiment 3.

A commercial specific surface area and pore structure analyzer measures the pore structure parameters of the adsorption material, and obtains the pore structure parameters of the adsorption material through the DFT cylindrical pore calculation model. Based on the ternary matching relationship equation (Equation 3.2) among the critical pore size D_{C} that can undergo volume-filling adsorption, the critical relative pressure P_{C}/P₀ and the adsorption temperature T in Embodiment 3, combined with the obtained pore structure parameters of the adsorption material, according to the cumulative pore volume and the cumulative specific surface area with the change of the pore size, the critical pore volume V_{C} and the critical specific surface area S_{C} corresponding to the critical pore size D_{C} under the corresponding adsorption conditions (adsorption temperature T, and relative pressure P/P₀) are obtained.

The ternary matching relationship equation among the critical pore size D_{C} and the critical relative pressure P_{C}/P₀ and the adsorption temperature T in Embodiment 3 is as follows:

$${D}_{C} = ( {P}_{C} / {P}_{0} - 0.000253 \times T + 0.227 ) / ( 0.00041 \times T + 0.1 \; 18 ) , \qquad Equation 3.2 ;$$

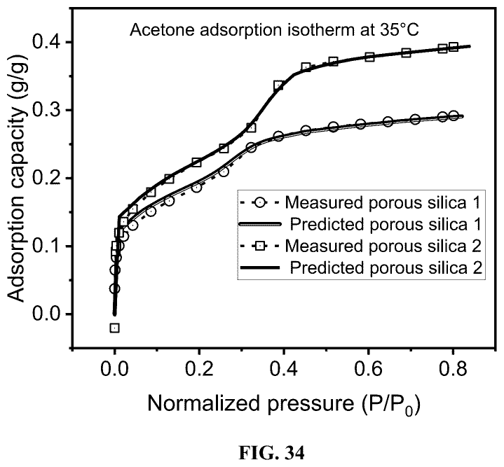

and the parameters such as the critical pore volume V_{C} and the critical specific surface area S_{C} corresponding to the critical pore size D_{C} under the corresponding adsorption conditions are substituted into the acetone across-temperature adsorption capacity prediction equation (Equation 4.2) as known data, and the trend of changes in adsorption capacity with relative pressure at the corresponding adsorption temperature is determined, as shown in FIG. 34.

In Embodiment 3, the acetone across-temperature adsorption capacity prediction equation is:

$$Q = ( 0.5 + 0.057 \times {D}_{A V} + 0.12 \times P / {P}_{0} - 0.00115 \times T ) \times {V}_{C} + ( ( 0.001 \; 85 - 0.000266 \times {D}_{A S} ) \times P / {P}_{0} + ( 0.000176 + 0.00000857 \times {D}_{A S} ) - 6.5 \times 1 {0}^{- 7} \times T ) \times {S}_{C} ; \qquad Equation 4.2$$

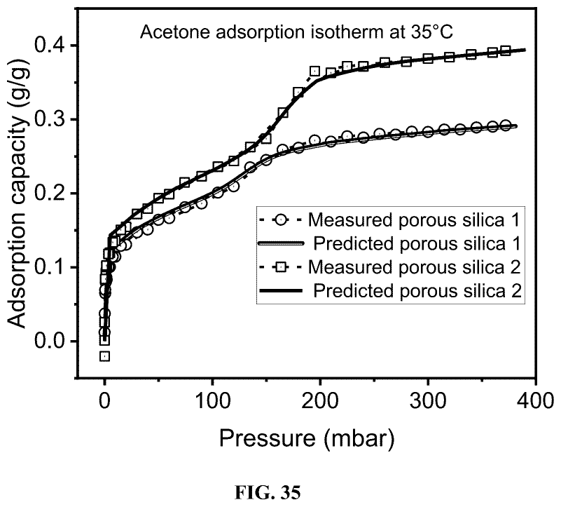

By multiplying the relative pressure P/P₀ of the predicted adsorption isotherms by the saturated vapor pressure P₀ (464.28 mbar) at the corresponding temperature (35° C.), the adsorption isotherms of acetone on the two kinds of porous silica adsorption materials before normalization at 35° C. are calculated, which are the predicted adsorption isotherms, as shown in FIG. 35. FIG. 35 shows a comparison between predicted and measured adsorption isotherms for two kinds of porous silica material without the concentrated pore size distributions. It can be observed from FIG. 35 that the predicted adsorption isotherm of acetone at 35° C., provided by the method of the present disclosure, coincides closely with the adsorption isotherm obtained through the experimental test.

The above shows that the method of the present disclosure is also applicable to the prediction of adsorption capacity and adsorption isotherms of specific VOCs for other adsorption materials without concentrated pore size distributions at different adsorption temperatures. The acetone across-temperature adsorption capacity prediction equation, obtained by using the silica-based adsorption material in Embodiment 3, can be directly used to predict the adsorption capacity of other silica-based adsorption materials without concentrated pore size distributions. Consequently, in cases where the material composition and surface properties are similar, the obtained adsorption capacity prediction equation can be directly used to predict the adsorption capacity and adsorption isotherms of other adsorption materials at different adsorption temperatures. It shows that the VOCs adsorption capacity and the adsorption isotherm prediction method of the present disclosure have good generalizability.

Conclusively, based on the theoretical foundation that adsorption of VOCs by porous materials involves both volume-filling adsorption and surface-covering adsorption, a regularity equation for the critical pore size enabling volume-filling adsorption under different adsorption conditions (temperature, relative pressure) is derived. Based on the contributions to VOCs adsorption capacity from the pore volume V_{C} of pores undergoing volume-filling adsorption and the specific surface area S_{C} of pores undergoing surface-covering adsorption, the fundamental structure of the adsorption capacity prediction equation is derived: Q=a×V_{C}+b×S_{C}. By introducing coefficients for volume-filling adsorption and surface-covering adsorption with pore diameter D, relative pressure P/P₀, and adsorption temperature T as variables, an across-temperature VOCs adsorption capacity prediction equation is obtained. This equation can be utilized to predict the adsorption capacity and isotherm of VOCs by adsorbents with identical or similar surface properties at different adsorption temperatures. Based on the obtained across-temperature VOCs adsorption capacity prediction equation, the critical pore volume V_{C} and critical specific surface area S_{C} corresponding to the critical pore size D_{C} under the corresponding adsorption conditions (adsorption temperature T, and relative pressure P/P₀) can be substituted into the equation as known data through the pore structure parameters of the adsorption material, and the trend of changes in adsorption capacity with relative pressure at different adsorption temperatures can be determined. By multiplying the relative pressure P/P₀ of the predicted adsorption isotherm by the saturated vapor pressure P₀ at the corresponding temperature, the predicted adsorption isotherm before normalization at the corresponding adsorption temperature can be obtained. The VOCs adsorption capacity and adsorption isotherm at various temperatures can be predicted by the same equation. The VOCs adsorption capacity and adsorption isotherm prediction method of the present disclosure has good generalizability, which has important reference value for the optimization of adsorption materials and technologies.

The above description pertains only to preferred embodiments of the present disclosure. It should be noted that for those skilled in the art, numerous modifications and improvements may be made without departing from the principles of the present disclosure. Such modifications and improvements should also be regarded as falling within the scope of the present disclosure.

What is claimed is:

1. A method for predicting adsorption capacity of volatile organic compounds across adsorption temperatures, comprising the following steps:
step (1), providing at least two porous materials with concentrated pore size distributions as model adsorption materials, and measuring pore structure parameters of the model adsorption materials, wherein the pore structure parameters comprise a pore size distribution, a change of a cumulative pore volume with the pore size distribution, a total pore volume V, a change of a cumulative specific surface area with the pore size distribution, and a total specific surface area S;
step (2), measuring adsorption isotherms of one model adsorption material for specific VOCs at a plurality of adsorption temperatures, and obtaining normalized static adsorption isotherms by dividing each pressure point on the static adsorption isotherms by saturated vapor pressure P₀ at corresponding temperatures;
wherein according to the normalized static adsorption isotherms, a corresponding relative pressure range when a volume-filling adsorption forms in the model adsorption material can be obtained, and an intermediate value of the relative pressure range is taken as a critical relative pressure P_{C}/P₀; wherein the critical relative pressure P_{C}/P₀ is correlated with an intermediate value of the pore size distribution of the model adsorption material, and the intermediate value of the pore size distribution is taken as a critical pore size D_{C} for a formation of the volume-filling adsorption at the critical relative pressure P_{C}/P₀;
linearly fitting the critical relative pressure P_{C}/P₀ and adsorption temperature T of the model adsorption material, obtaining a linear relationship equation between the critical relative pressure P_{C}/P₀ and the adsorption temperature under a specific pore size, wherein:
$${P}_{C} / {P}_{0} = {k}_{P} \times T + {d}_{P} , \qquad Equation 1 ;$$
where P_{C}/P₀ is the critical relative pressure of a critical pressure P_{C} with respect to a saturated vapor pressure P₀ at a corresponding adsorption temperature;
T is the adsorption temperature, and a unit is ° C.;
k_{P} is a slope of the linear relationship between relative pressure and adsorption temperature;
d_{P} is a value of P_{C}/P₀ when the relative pressure approaches 0 in the linear relationship;
according to different P_{C}/P₀ values corresponding to different adsorption temperatures T of the model adsorption materials, determining the coefficients k_{P} and d_{P} in Equation 1 corresponding to the model adsorption materials;
step (3), obtaining coefficients k_{P} and d_{P} in Equation 1 corresponding to other model adsorption materials with reference to the method of step (2);
step (4), for a plurality of critical pore sizes D_{C}, linearly fitting k_{P} and d_{P} from the linear relationship equations between the critical relative pressure P_{C}/P₀ and the adsorption temperature T with respect to the respective critical pore sizes D_{C}, and obtaining linear relationship equations k_{P}=k_{P1}×D_{C}+k_{P0} and d_{P}=d_{P1}×D_{C}+d_{P0} of the changes in coefficients k_{P} and d_{P} with the critical pore sizes D_{C}, respectively, thereby obtaining a linear relationship equation of the volume-filling adsorption critical relative pressure P_{C}/P₀ with the changes in the adsorption temperature T and the pore size D_{C}, wherein:
$${P}_{C} / {P}_{0} = ( {k}_{P 1} \times {D}_{C} + {k}_{P 0} ) \times T + ( {d}_{P 1} \times {D}_{C} + {d}_{P 0} ) , \qquad Equation 2 ;$$
where P_{C}/P₀ is the critical relative pressure of a critical pressure P_{C} with respect to the saturated vapor pressure P₀ at a corresponding adsorption temperature;
T is the adsorption temperature, and the unit is ° C.;
D_{C} is the critical pore size, which may form volume-filling adsorption when the relative pressure is P_{C}/P₀, and a unit is nm;
k_{P1} and k_{P0} are slope and intercept of the linear relationship equation between k_{P} and critical pore size D_{C}, respectively;
d_{P1} and d_{P0} are slope and intercept of the linear relationship equation between d_{P} and critical pore size D_{C}, respectively;
utilizing the Equation 2 to obtain a matching relationship equation between the critical pore size D_{C} for volume-filling adsorption and the adsorption temperature T for volume-filling adsorption when the relative pressure P_{C}/P₀ is different, wherein:
$${D}_{C} = ( {P}_{C} / {P}_{0} - {k}_{P 0} \times T - {d}_{P 0} ) / ( {k}_{P 1} \times T + {d}_{P 1} ) , \qquad Equation 3 ;$$
where D_{C}, P_{C}/P₀, T, k_{P1}, k_{P0}, d_{P1} and d_{P0} denote the same meaning as in Equation 2;
step (5) taking the critical pore size D_{C} as a demarcation point, according to the change of cumulative pore volume with pore size distribution and the change of cumulative specific surface area with pore size distribution measured by the pore structure parameters, obtaining a pore volume V_{C} of the pores below the critical pore size D_{C} and a specific surface area S_{C} of the pores above the critical pore size D_{C} for the model adsorption material, respectively;
step (6), based on a contribution of the pore volume V_{C} of the pores where volume-filling adsorption forms and the specific surface area S_{C} of the pores where surface-covering adsorption forms to the VOCs adsorption capacity, and introducing the pore size, relative pressure and adsorption temperature of different model adsorption materials as parameters into the adsorption capacity prediction equation, obtaining an across-temperature VOCs adsorption capacity prediction equation, which enables the adsorption isotherms prediction to be extended to different adsorption temperatures T, wherein:
$$Q = a \times {V}_{C} + b \times {S}_{C} = f ( {D}_{A V} , P / {P}_{0} , T ) \times {V}_{C} + g ( {D}_{A S} , P / {P}_{0} , T ) \times {S}_{C} ; \qquad Equation 4$$
where Q is a quantity of adsorbed VOCs per unit mass of adsorption material, and a unit is g/g;
V_{C} is the pore volume of the pores below the critical pore size, that is, the critical pore volume, and a unit is cm³/g;
S_{C} is the specific surface area of the pores above the critical pore size, that is, the critical specific surface area, and a unit is m²/g;
D_{AV} is an average pore size of the pores where volume-filling adsorption forms, and a unit is nm; wherein D_{AV}=4V_{C}/(S−S_{C}), S is a total specific surface area, and a unit is m²/g;
D_{AS} is an average pore size of the pores where surface-covering adsorption forms, nm; where D_{AS}=4 (V−V_{C})/−S_{C}, V is a total pore volume, and a unit is cm³/g;
T is the adsorption temperature, and the unit is ° C.;
P/P₀ is any relative pressure point on the adsorption isotherm normalized to the saturated vapor pressure at the corresponding temperature; P₀ is saturated vapor pressure of VOCs at the corresponding adsorption temperature T, and a unit is mbar;
a is a coefficient of the volume-filling adsorption, that is, the adsorption capacity of VOCs per unit pore volume, and a unit is g/cm³, where α=f(D_{AV}, P/P₀, T) denotes that the coefficient a is a function of the average pore size D_{AV}, the relative pressure P/P₀ and the adsorption temperature T;
b is a coefficient of the surface-covering adsorption, that is, the adsorption capacity of VOCs per unit specific surface area, and a unit is g/m², where b=f(D_{AS}, P/P₀, T) denotes that the coefficient b is a function of the average pore size D_{AS}, the relative pressure P/P₀ and the adsorption temperature T;
step (7), by measuring the pore structures of a plurality of model adsorption materials and the adsorption isotherms under different adsorption conditions, obtaining the critical pore size D_{C}, quantity of adsorbed VOCs Q, critical pore volume V_{C}, critical specific surface area S_{C}, and average pore sizes D_{AV} and D_{AS} under the corresponding conditions, taking the pore structure parameters of the model adsorption materials and the adsorption isotherms of specific VOCs under different adsorption conditions as known data to substituting them into Equation 4 to obtain specific values of a and b, and obtaining the across-temperature VOCs adsorption capacity prediction equation.

2. The method according to claim 1, wherein the model adsorption material is at least one of an ordered mesoporous silica, an ordered mesoporous carbon and molecular sieves with concentrated pore size distributions.

3. The method according to claim 1, wherein the VOCs are one of hydrocarbon organics, oxygen-containing organics, halogen-containing organics, nitrogen-containing organics and sulfur-containing organics.
